(19) United States
(12) Patent Application Publication
(10) Pub. No.: US 2011/0319160 A1
(43) Pub. Date: Dec. 29, 2011

(54) Systems and Methods for Creating and Delivering Skill-Enhancing Computer Applications

(75) Inventors: Robert Arn, Kelowna (CA); Andrew Agno, Kelowna (CA); Jonathon Balogh, Kelowna (CA); Cayley Humphries, Kelowna (CA)

(73) Assignee: IDEVCOR MEDIA, INC., KELOWNA (CA)

(21) Appl. No.: 13/168,225

(22) Filed: Jun. 24, 2011

Related U.S. Application Data
(60) Provisional application No. 61/358,808, filed on Jun. 25, 2010.

(51) Int. Cl. A63F 13/00

(52) U.S. Cl. 463/30

(57) ABSTRACT

Systems and methods are disclosed for creating and delivering skill-enhancing applications based on pre-recorded media content without altering the prerecorded media content.

This is a continuation-in-part of our provisional application Ser. No. 61/358,808, filed Jun. 25, 2010.

### FIELD OF THE INVENTION

The present invention relates generally to computer application development and to pre-recorded digital media content. More specifically, the present invention relates to creating a computer application interactive experience by coordinating independent, parallel components, one of which is pre-recorded media content.

### BACKGROUND OF THE INVENTION

This invention describes methods of creating and distributing computer applications for skill enhancement that are based on new media structures and delivery modes that have become commonplace on the internet. Skill enhancing applications are differentiated from other computer applications such as typical productivity software by virtue of being designed to teach or enhance a skill rather than to provide a tool to exercise a pre-existing skill. For instance, it is obviously the case that a word processing computer application is a productivity tool; it is not a skill enhancing application in that it does not improve the expressive quality of the user's writing, but only provides an efficient tool to exercise the pre-existing skill.

Skill enhancing applications span a number of categories including education and training applications. Less intuitively, certain types of computer games may be skill enhancing applications in that progress in the game rests on refining a particular skill which is central to the game play. Often this skill is simply some form of hand-eye coordination. However, in some cases, games may enhance a higher-order skill.

The essence of a skill enhancing application is that it embodies some reference model of the skill to be developed, along with a set of tasks that cause the user to attempt repetitively to imitate some aspect of the reference model, a means of comparing the user's imitation to the reference model and a feedback mechanism that scores the user's success, thus allowing him or her to progressively converge their performance with the desired reference skill model.

Part of the challenge of creating skill-enhancing applications is the creation of the reference model of the skill to be enhanced. A simple example might be the creation of a flight simulator such as Flight Simulator by Microsoft Corporation. The reference model must include mathematical simulations of the basic physics of flight and the controls of a particular airplane. These must be combined with computer animation means to present the controls and flight behavior of the airplane to the learner through a graphic presentation such as a computer screen. A training session will encode a particular task like a flight plan; the user's control inputs are compared to the reference model and deviations are fed back into the presentation system, showing the consequences of failing to conform to the reference model. Creating such integrated computer-graphic models for skill enhancing is time-consuming and expensive.

The utility of using pre-recorded digital media content as the basis of the reference model of a skill-enhancing application is attractive as an alternative to the creation of such complex computer-graphic simulation systems. The skills required to create the two primary forms of digital media content, audio and video, are commonplace compared to the skills required to create computer-graphic models. The realism of such digital media content is high and the tools required to create such content are increasingly available and inexpensive in the mass-market. Moreover, there exists a vast archive of already created content from radio, movies, television and music that would be very valuable if it could be adapted to form the basis of reference models for skill-enhancing applications. However, certain characteristics of pre-recorded digital media have limited its use in creating such applications.

Discussing the background of using pre-recorded digital media as the basis of skill-enhancing applications requires clarification of certain confusing terminology in common use. First, the term “video” is commonly used to describe two quite different things—linear visual presentations such as movies or TV programs on the one hand and non-linear computer applications often called “video games” on the other. In describing the current invention, we shall reserve the term “video” for linear visual presentations and use the term “computer game” to describe interactive skill-enhancing computer applications that have game-like characteristics. Second, there are two different forms of storage and delivery of pre-recorded digital media—file/record based media and streaming media—and the differences are critical elements as to the systems and methods that may be used to exploit such media content.

So called “video games” which we shall call “computer games”, typically consist of a 2D or 3D computer animation model, running on dedicated game devices (such as the Xbox 360 from Microsoft, the PlayStation 3 from Sony, or the Wii from Nintendo) that are driven by user input events to produce a unique, non-linear, interactive experience for each user. A generic architectural diagram of such prior art computer games is set out in FIG. 1. A similar game architecture may be deployed on a general purpose personal computer as set out in FIG. 2. In both such cases, the game logic and data is stored on storage devices such as Read-Only Memory game cartridges, hard disc drives, or optical disc drives as files or records in a data structure. As we see in FIGS. 1 and 2, the method of playing such prior art computer games involves the player interacting through a peripheral device, keyboard, mouse or specialty controller with the game logic which accesses the game animation model and stored data, updating the animation model state and presenting it back to the player. We can call this a closely-coupled interactive architecture because player interaction with the game logic directly drives all the state sequences of the data presented to the player. The animation model does not operate autonomously from the player's interaction with the game logic. In skill-enhancing applications, the animation model incorporates a reference model of the skill, as described above.

In contrast, in this invention “video” will refer to a pre-recorded visual presentation that optionally includes audio information, created either by a camera recording live action, or by assembling segments of graphic material into a finished presentation which is experienced in a linear, fixed sequence without any interactive input from the viewer, so that each viewer's experience is essentially the same. Video is thus very similar to its precursor motion pictures, where the linear, fixed experience was imposed by the physical limitations of motion picture film which can only be projected in a fixed sequence. Television, the most familiar form of video, retains the fixed linear conventions of motion pictures. More generally, digital media may include forms of linear media such as audio, dialog, sound effects, music and narration, which may as well be sub-components of video. Such linear media can only be affected by users in very limited ways. The user's control is typically limited to starting or stopping the media play and adjusting audio levels, brightness and contrast of the video graphic content. The media operates autonomously and is essentially uncoupled from user interaction. To the extent that linear media may implicitly encode a reference skill, they can be thought of more as examples or performances of the skill, rather than a closely-coupled interactive skill model which is often the foundation of a traditional computer game.

There have been a number of modes of using linear media within the closely-coupled non-linear conventions of skill-enhancing applications including computer games. The simplest is to divide linear media into segments which are stored as files or records within the computer game and individually retrieved, as represented in FIG. 3. As we see in FIG. 3, this is a variant on the closely-coupled architecture of FIGS. 1 and 2. The player interacts with the application logic, which selects the next segment of linear media to present back to the user, synthesizing a non-linear sequence from the juxtaposition of linear fragments. Again, the media content is closely-coupled to the user interaction through the application logic and does not have any autonomous identity.

A more sophisticated use of linear video uses it as a source of models of natural movement for animation using a technique called motion capture. The motion capture technique records video of live actors with markers attached to limbs and joints so that the motions of the limbs and joints may be transferred to a three dimensional computer animation model. The computer animation model may then be used to produce realistic movements on demand in non-linear sequences. Similarly, video may be used as a source of realistic textures to be applied to computer generated structures or characters. In both these cases the structure and data of the original video are destroyed as the desired features are absorbed into the animation model, resulting in an architecture, set out in FIG. 4, that is substantially identical to the closely-coupled architecture of FIGS. 1 and 2.

Attempts to use essentially linear video media content as a component of non-linear computer games has suffered from the difficulty of decomposing the video into forms that could support the radically different non-linear computer application architecture.

In the case of audio media, the field of music visualization has produced an interesting way to enhance the listener's experience of music by passing the music through an analytical processing stage which generates music pattern data to drive a graphic pattern generator, which outputs moving shapes and colors that are presented to the listener as a graphic channel in synchrony with the music. Most digital audio players, for instance Windows Media Player by Microsoft, now incorporates some form of music visualization.

There have been a number of proposals and products that seek to take the technique further in the case of music media, to create music-generated games. Released products include Beats by Sony Computer Entertainment, Audiosurf by Invisible Handlebar and Helix by Ghostfire Games among others. In such cases, the output of the music analytical processing stage is used to drive an animation model with which the user may interact and the user's performance may be evaluated and feedback provided. Such systems are useful in reducing the labor required to create music games of the genre made familiar by popular products such as Guitar Hero and Rock Band, however, they have not reduced the labor and complexity of delivering a high quality immersive graphic experience for user interaction, or provided a method to use pre-existing video content or publically available streaming media without requiring possession of the media content on physical media such as CDs or copying the media content to disk.

The potential importance of pre-recorded digital media has risen dramatically in the last few years. The combination of increased accessibility of video recording tools and a free distribution channel provided by internet web sites such as YouTube, has led to an explosion of short form video media content of diverse types. This form of video is commonly referred to as ‘User Generated Content”, although it also includes professionally produced video content. Today, such videos represent the largest repository of accessible video in the world, viewed by hundreds of millions of people per month. As well, audio media are increasingly accessible through interne radio services and such music services as Spotify and LaLa. Unlike previous media access services such as Napster and BitTorrent, and present services such as iTunes from Apple Computer, the new media access services do not download copies of files to be stored on the user's computer, but streams of data which can be presented, but not stored on the user's computer. The source file of the media remains on a server of the service provider.

Such services are delivered through new protocols such as RTMP from Adobe Systems Inc. or modifications of existing file-transfer protocols such as HTTP. Such protocols are generically known as streaming protocols. In using streaming protocols to access media on the internet, a user does not download and locally store a file in the way that is still done by services such as iTunes by Apple Computer Inc. Rather, the user receives the media in a stream and plays it immediately, keeping no stored copy. This is rather like the reception of media through analog radio or television. However, the streaming model applied to digital media allows for each delivered stream of a piece of media content to be identical, independent of the time of access or the path of delivery, opening the possibility of using streaming media predictably in computer applications.

However, in themselves, the new services and streaming protocols do not provide a way of incorporating the media into applications and the media content itself still retains the linear, fixed presentation sequence convention of traditional linear media. The traditional closely-coupled architecture and attendant methods of creating and distributing traditional non linear skill-enhancing applications and computer games using file or record storage preclude any substantial use of this massive on-line store of streaming media that is directly available to the public. The closely-coupled architecture of such traditional applications and games usually requires access to the root files or records of the media, modifications of the original media format and fragmentation of the media data which is unavailable via the streaming services which provide the media access.

There would be great utility in systems and methods that allowed the vast resource of video media content already in existence to be used to create interactive skill-enhancing applications and re-used as is, without any requirement for extensive planning, modification and re-production of the media content. Further, there would be very great utility in systems and methods that allowed the use of freely available streaming media content from network audio and video streaming media sites to be used to create interactive computer skill-enhancing applications and re-used in the streaming format of the originating sites, without any requirement for storing, modifying the content or incorporating it within the skill-enhancing applications. Such systems and methods, based on a new loosely-coupled computer application architecture, are the substance of the invention described in this specification.

### SUMMARY OF THE INVENTION

In one embodiment, the present invention provides systems and methods for creating and delivering skill-enhancing applications based on pre-recorded video media content without altering the prerecorded video media content. The systems and methods are based on a loosely-coupled architecture in which the pre-recorded video media content is independent of the application logic. Instead of integrating the video media content into the application logic, the application logic synchronizes to the video media content. The pre-recorded video media content may be accessed from user computing device storage or a connection to a network through a wired or wireless connection. The skill-enhancing application may be used on a computer, mobile phone, gaming console, or other user computing device capable of retrieving and presenting video media content as well as providing user input and computational facilities simultaneously.

In this embodiment, creating the skill-enhancing application includes accessing pre-recorded video media content, analyzing the pre-recorded video media content, extracting metadata descriptions from the video media content indicative of the skill to be enhanced, storing and optionally processing such metadata descriptions separate from the pre-recorded video media content and associating one or more elements of extracted metadata with a desired user response.

In this embodiment, delivering the skill-enhancing application includes accessing and retrieving the unaltered pre-recorded video media content to a user computing device, accessing at least one element of extracted metadata associated with a desired user response and comparing the extracted metadata indicative of the desired user response to the actual user response, then providing feedback which allows the user to attempt to adapt his responses more closely to the desired response.

Another embodiment of the present invention provides systems and methods for creating and delivering skill-enhancing applications based on pre-recorded streaming media content from network-accessible streaming media servers without altering the media content streams. The systems and methods are based on a loosely-coupled architecture in which the pre-recorded media content stream is independent of the application logic. Instead of integrating the media content into the application logic, the application logic synchronizes to the media content stream. The pre-recorded media content streams may be accessed from a user client computing device connected to a network through a wired or wireless connection. The skill-enhancing application may be used on a computer, mobile phone, a gaming console, or other user client computing device capable of retrieving and presenting media content streams as well as providing user input and computational facilities simultaneously.

In this second embodiment, creating the skill-enhancing application includes accessing a pre-recorded media content stream from a network-accessible streaming media server, analyzing the pre-recorded media content stream, extracting metadata descriptions from the media content indicative of the skill to be enhanced, storing and optionally processing such metadata descriptions separate from the pre-recorded media content and associating one or more elements of extracted metadata with a desired user response.

In this second embodiment, delivering the skill-enhancing application includes accessing and retrieving the unaltered pre-recorded media content stream from a network-accessible streaming media server to a user computing device, accessing at least one element of extracted metadata associated with a desired user response from a different server and comparing the extracted metadata indicative of the desired user response to the actual user response, then providing feedback which allows the user to attempt to adapt his responses more closely to the desired response.

### BRIEF. DESCRIPTION OF THE DRAWINGS

FIG. 1 is a diagram of the closely-coupled architecture of a typical prior art non-linear skill-enhancing application or computer game running on a gaming console.

FIG. 2 is a diagram of the closely-coupled architecture of a typical prior art non-linear skill-enhancing application or computer game running on a personal computer.

FIG. 3 is a diagram of the architecture of a typical prior art non-linear skill-enhancing application or computer game using segments of linear media adapted to the closely-coupled architecture.

FIG. 4 is a diagram of the architecture of a typical prior art non-linear skill-enhancing application or computer game showing how linear media can be absorbed into the closely-coupled architecture of the application.

FIG. 5 is a diagram of a general embodiment of the present invention, showing the loosely-coupled architecture of a distributed parallel skill-enhancing application based on the present invention utilizing pre-recorded media content.

FIG. 6 is a diagram of a general first embodiment of the present invention, showing the creation and delivery of a loosely-coupled distributed parallel skill-enhancing application based on pre-recorded video digital media content.

FIG. 7 is a diagram of a general second embodiment of the present invention, showing the creation and delivery of a loosely-coupled distributed parallel skill-enhancing application based on pre-recorded streaming media content from a network-accessible streaming media server.

FIG. 8 is a diagram of a representative embodiment of the present invention, showing a loosely-coupled distributed parallel language-learning skill-enhancing application based on pre-recorded video media content or on a pre-recorded media content stream.

FIG. 9 is a diagram detailing the metadata extraction and processing functions of the language-learning representative embodiment of the present invention.

FIG. 10 is a diagram of a representative embodiment of the present invention, showing a music instructional skill-enhancing application based on pre-recorded video media content or on a pre-recorded media content stream.

FIG. 11 is a diagram detailing the metadata extraction and processing functions of the music instructional representative embodiment of the present invention.

FIG. 12 is a diagram of a representative embodiment of the present invention, showing a maintenance training skill-enhancing application based on pre-recorded video media content or on a pre-recorded media content stream.

FIG. 13 is a diagram detailing the metadata extraction and processing functions of the maintenance training representative embodiment of the present invention.

FIG. 14 is a diagram of a representative embodiment of the present invention, showing a music computer game based on pre-recorded video media content or on a pre-recorded media content stream.

FIG. 15 is a diagram detailing the metadata extraction and processing functions of the music computer game representative embodiment of the present invention.

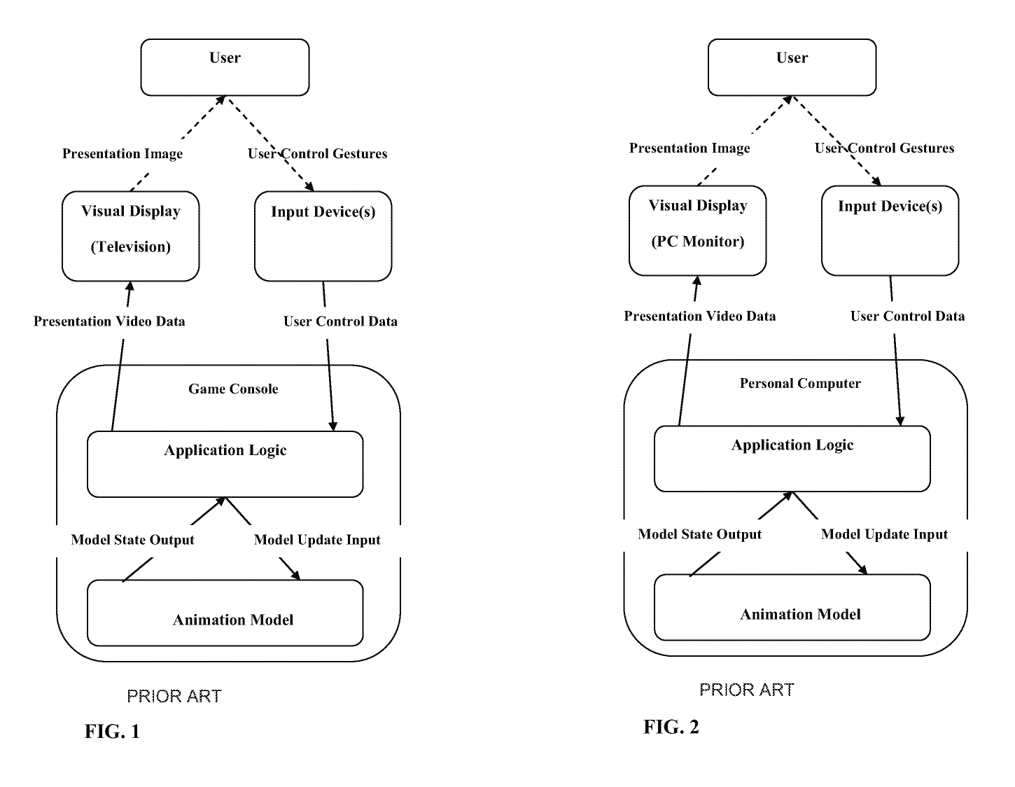

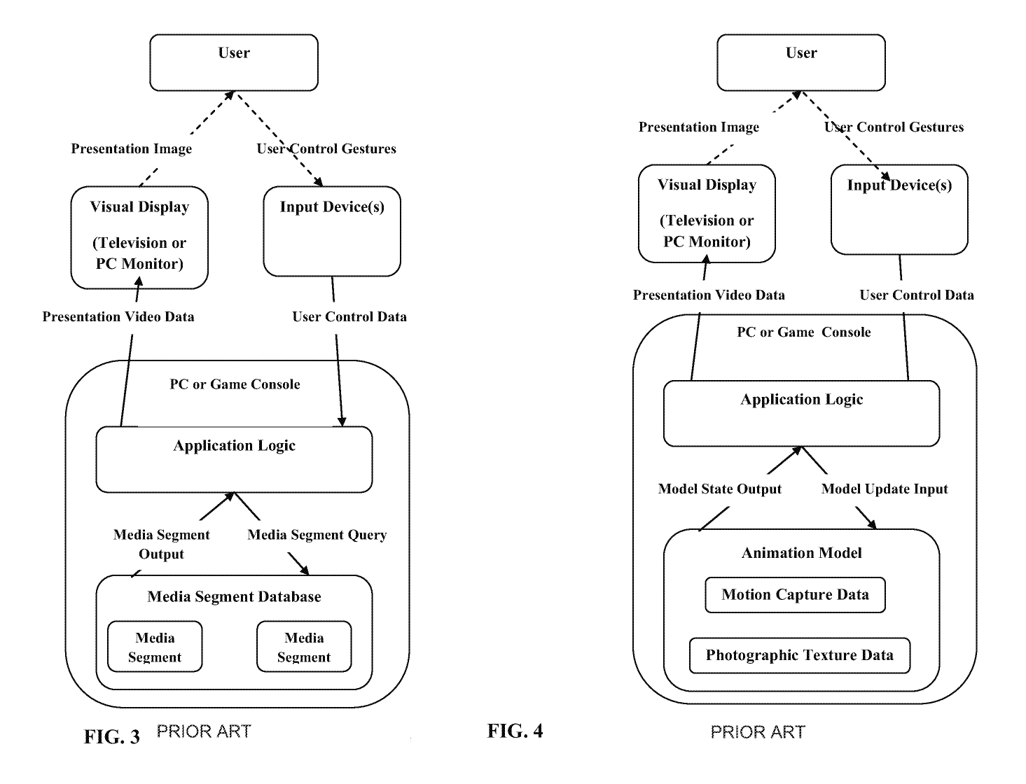

### DETAILED DESCRIPTION OF THE INVENTION

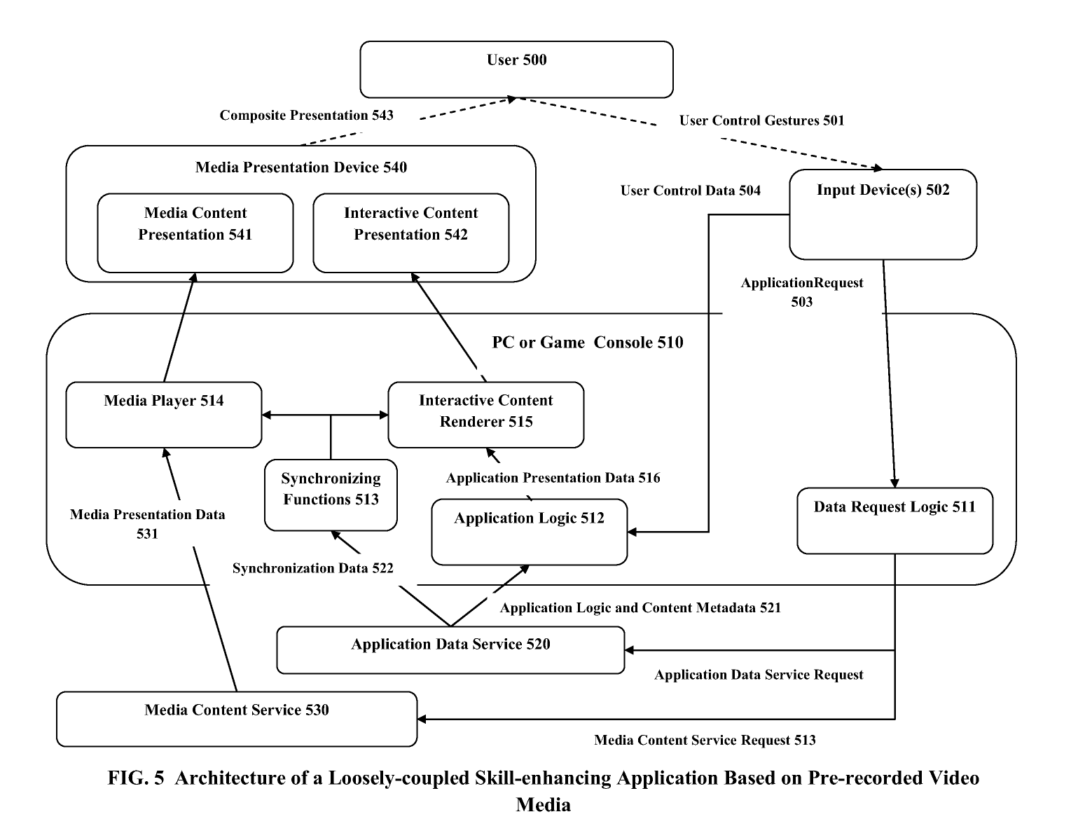

FIG. 5 presents a skill-enhancing application implemented with a loosely-coupled distributed, parallel architecture according to the present invention, showing differences from the closely-coupled architecture of traditional skill-enhancing applications and computer games represented in FIGS. 1,2,3 and 4. In FIG. 5, the User 500 initiates an application by making a request by manipulating Input Device(s) 502 with User Control Gestures 510, generating an Application Request 503 to Data Request Logic 511 which, in turn, generates at least two data requests, Application Data Service Request 512 to Application Data Service 520, and Media Content Service Request 513 to Media Content Service 530.

A practitioner skilled in the art will recognize that Application Data Service 520 and Media Content Service 530 are represented in the conventions of a Service Oriented Architecture (SOA) and may be implemented in several forms. They might for instance be implemented as separate services running on the PC or Game Console accessing local or remote data, or they may be implemented as external services running on a remote server or servers and communicating with the PC or Game Console through a Local Area Network (“LAN”) or a Wide Area Network (“WAN”) such as the internet. Equally, they may provide data via file transfer, record transfer or stream transfer protocols. In all cases, they are essentially independent services that need have no control elements in common. The only requirement of these services is that they provide a request interface that is accessible to the Media Player 514, Application Logic 512 and Synchronizing Functions 513 and return the requested data when presented with a properly formatted request.

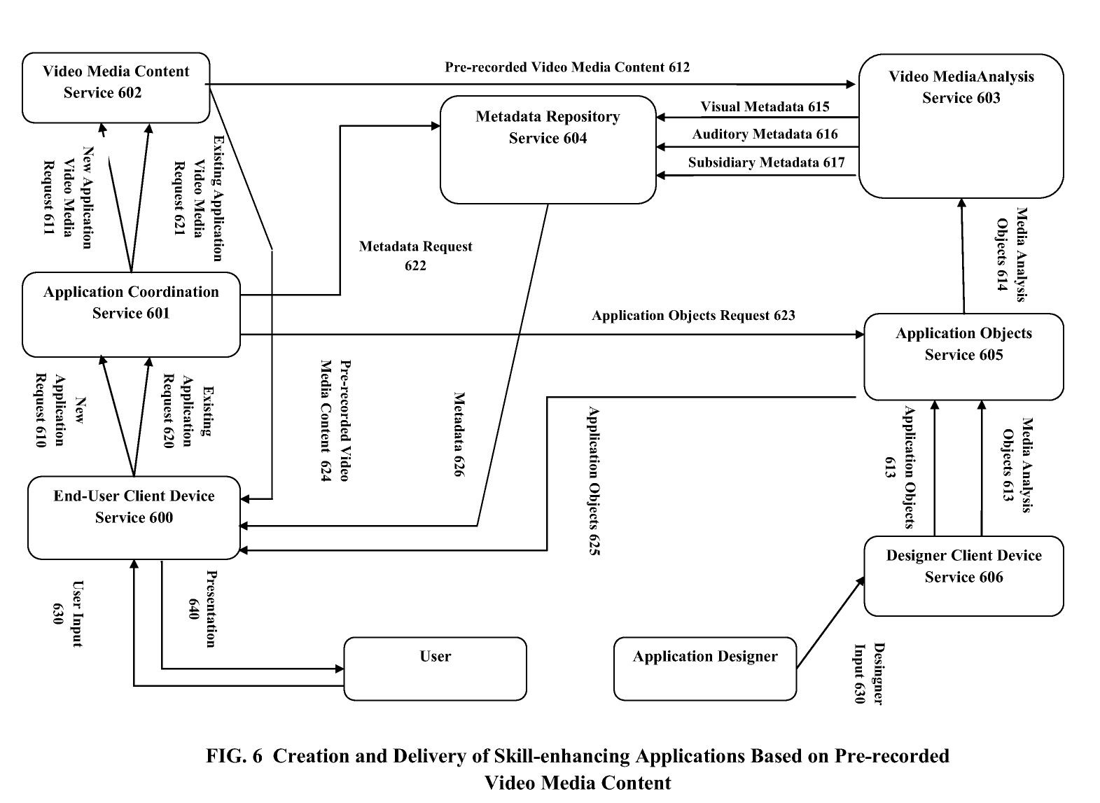

An example of such a service/request structure for Media Content Service 530 is implemented by the YouTube video streaming service, whereby a URL request from a web browser such as Internet Explorer from Microsoft will return a stream of video media content for a unique video for display in a media player. Application Data Service 520 contains the logic of the requested computer game as well as metadata which describes the media content to be presented in parallel with the game and specific metadata which allows synchronization of the application logic events with the streaming media content from the Media Content Service 530. The creation and delivery of the application data which is delivered from the Application Data Service 520 will be discussed in FIG. 6 and subsequent figures. The description of this FIG. 5 is to clarify the loosely-coupled, distributed, parallel architecture of the present invention relative to the closely-coupled architecture of traditional skill-enhancing applications.

Media Content Service 530 delivers Media Data 531 to Media Player 514 to the PC or Game Console 510 of User 500. The Application Data Service 520 delivers Application Logic and Content Metadata 521 and Synchronization Data 522 to Application Logic 512 and Synchronizing Functions 513 respectively. The Application Logic and Content Metadata 521 includes executable functions and data that enable the processing of user control functions, comparison of user interaction events with Metadata events and generation of game presentation elements.

Presentation elements of the game are delivered in Application Presentation Data 516 to Interactive Content Renderer 515 where they are rendered into a format suitable to present as a series of objects Interactive Content Presentation 542 in the Media Presentation Device 540 which may be a PC monitor or a TV attached to a gaming console. Media Player 514 similarly converts the Media Presentation Data 531 to a data format suitable to present a series of media content objects, Media Content Presentation 541. The final result is a Composite Presentation 543 which can be perceived by the User 500, who may then issue interactive User Control Gestures 501 through Input Device(s) 502 generating User Control Data 504 to drive the interactive functions of Game Logic 512 to continue the game interactive experience.

A key determining characteristic of this architecture is that the presentation objects of Media Content Presentation 541 and Interactive Content Presentation 542 are essentially independent of each other. They present simultaneously to the user in parallel, but they are only loosely related through Synchronization Data 522 forcing common timelines. As shown in Media Presentation Device 540, they may be totally separate presentations in separate windows of the display device as two separate experiences collocated temporally, but not spatially. However, it is also possible to maintain the independence of the media presentation objects, while generating a perceptual illusion of integration. This can be effected by positioning of the objects and by superimposition of the objects so that they are rendered over each other and perceptually integrated by the game player. Whatever, the perceptual integration of the two classes of presentation object, the essence of the loosely-coupled architecture is that it allows two or more independent sources of presentation, at least one of which is not directly controllable by the application, to be integrated into a common experience.

To provide a non-technical analogy, the loosely-coupled architecture is like the common music experience of playing “air guitar” or “conductor” to music heard in a radio broadcast. The experience of the music is extended by an independent activity which is unconnected, but in synchrony. The performer cannot influence the radio music in more than minimal fashion (by turning it on or off, or manipulating the radio controls), but the experience is enriched by the synchrony of the two experiences. The present invention describes systems and methods whereby the vast resource of pre-recorded media from traditional file-based repositories or streaming media content services such as YouTube, Spotify, LaLa and many others, can be experienced in synchrony with interactive computer games that expand their entertainment experience and extend their utility.

FIG. 6 presents a diagram of a first general embodiment of the system structure and methods of the present invention by which creation and delivery of a skill-enhancing application based on pre-recorded video media content is effected. It is organized as a service-oriented architecture (SOA) diagram The presentation of the system and methods of the present invention as a service architecture represents the fact that the invention may be embodied in numerous physical forms without altering the essential characteristics of the invention. For example, all of the services described in the diagram might execute on different server and client computers communicating on a wired or wireless local network or a wide area network such as the interne. Or, some mixture of services might execute on a single device and one or more other services might execute on other computing devices communicating on a network. A practitioner normally skilled in the art will perceive that the invention described is broadly independent of such variations in distribution of its functional components and that the descriptions provided are intended to include all possible combinations of computational devices and network variants.

Both automated and human-originated components are described. Preliminary to the automated process, one or more game designer/programmer(s) specify and produce executable functions that generate interactive objects that will execute in synchrony with the pre-recorded video media content to create a skill-enhancing application. In FIG. 6, the game designer/programmer(s) define and create two types of functions through Designer Client Device Service 606. The first type of functions is a set of functions, Media Analysis Specifications 613, that are passed to the Application Objects Service 605 and on to Media Analysis Service 603. These functions are a set of analytical functions that extract different types of metadata indicative of the skill to be mastered from the pre-recorded video media content. Media Analysis Service 603 executes these functions on Pre-recorded Video Media Content 612 and outputs categorized events Visual Metadata 615, Auditory Metadata 616 and Subsidiary Metadata 617 to Metadata Repository Service 604, where they are stored until retrieved for execution of the skill-enhancing application by the end user.

A practitioner normally schooled in the art will recognize that the video media analysis may include multiple media sub-streams, including visual, auditory and other data types. The field of both audio and video analysis has an extensive history and literature within the field of signal processing, pattern matching and filtering. Examples of media analysis will be described in more detail relative to specific examples of skill-enhancing applications later. Optionally, the extracted features, patterns and events may be transformed into other forms or combined to generate audio and video metadata that is more useful as data for constructing the skill-enhancing application from the pre-recorded video media.

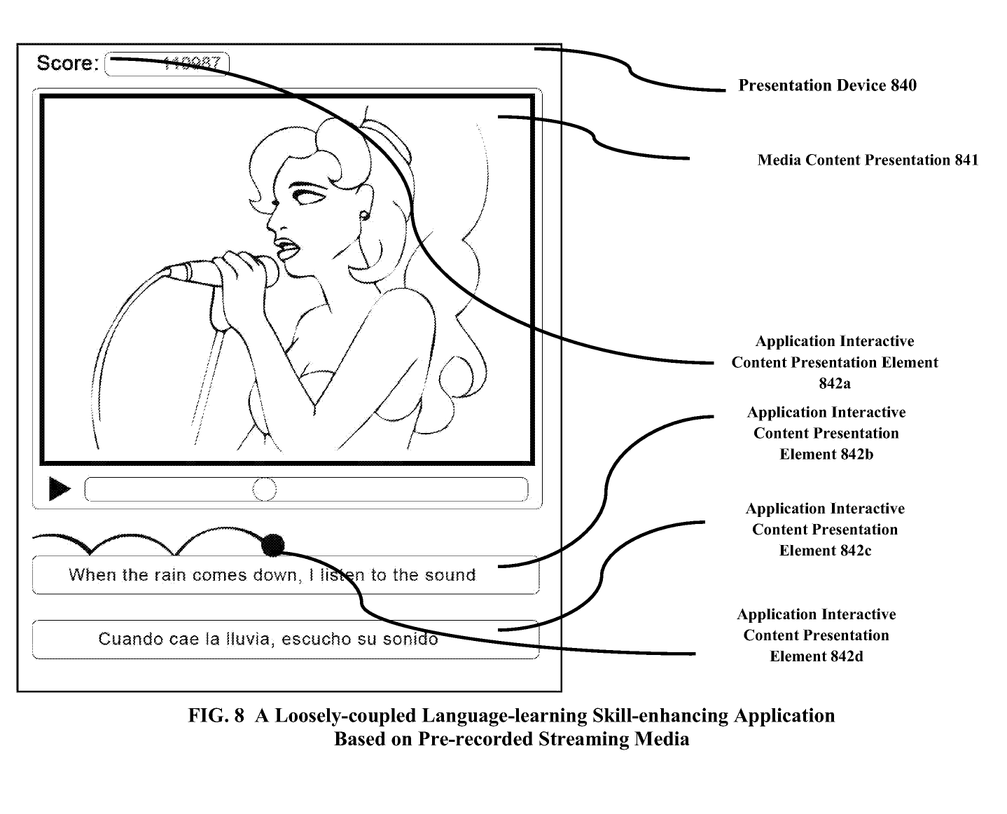

The Subsidiary Metadata is derived from a wide variety of data that may optionally be present in the pre-recorded video media (for example, subtitles, close captioning, author and rights information). An essential type of Subsidiary Metadata is a time representation to which the audio, video, audio metadata, video metadata, and other subsidiary metadata may be synchronized to the Pre-Recorded Video Media Content 612 as previously described in Synchronizing Functions 513 and Synchronization Data 522 shown in FIG. 5. The metadata that is extracted, processed and stored is specific to the individual skill-enhancing application. Description of the details of the metadata analysis performed in Media Analysis Service 603 will be described in more detail in relation to the representative skill-enhancing applications described in FIGS. 8 to 15.

As described in FIG. 5, it is a feature of the loosely-coupled architecture of the present invention that Pre-recorded Video Media Content 612 is substantially independent of the other components of the system. Thus, the game designer and provider has many choices as to the location and communication between the other services of the system such as Video Media Analysis Service 603, Computer Game Definition Service 605, Metadata Repository Service 604, Application Coordination Service 601, Designer Client Device Service 606 and Video Media Content Service. Visual Metadata 615, Auditory Metadata 616 and Subsidiary Metadata 617 are stored in Metadata Repository Service 604, but Pre-recorded Video Media Content 612 may not be stored in the application system at all because, in many cases, the providers of media content are constrained by copyright and media usage rights constraints, limiting the choice of storage means for the content.

It is thus important in such cases that the Pre-recorded Video Media Content 612 is used only to generate descriptive metadata and not modified or stored in the system. In such case, the skill-enhancing application uses the Pre-recorded Video Media Content 612 exactly as provided by the external Video Media Content Service 602 without making any change to it or storing any copy of it. The essence of this embodiment of the current invention is the use of video media content as the basis of the skill-enhancing application, independent of the format of the data (file, database record, stream, etc.), the locale of storage (local client computing device or network server), or the mode of data transfer (file transfer protocol, or streaming media protocol).

The second type of functions created by the designer/programmer through Designer Client Device Service 606 are Application Objects 613 which extend the user's experience of the pre-recorded media as it is played, without modifying the pre-recorded media stream data itself and which define the application responses to end-user inputs. Application Objects 613 include four categories of functions. First, are functions that add to the graphical or auditory experience of the pre-recorded media. For example, such functions might overlay explanatory text, graphics, or animations, or add audio voice or music overlays to the independent pre-recorded video media.

Second, are functions that add interfaces for human interaction with the application. The functions and interfaces envisaged in the present invention are oriented to providing a framework for user interaction with the type of application being created and support a broad range of input peripherals, including any peripheral device that can communicate with the End User Client Device Service 600 to provide User Input 630, for example, wired or wireless pointing devices, keyboards, joysticks, graphic tablets, mobile phones and other mobile devices, special purpose devices related to specific input/output styles such as the simulated game artifacts or musical instruments used for music games on video game consoles, and actual independent electronic special purpose devices incorporating computer data or control interfaces, such as, for example, any electronic musical instrument that incorporates a MIDI interface.

Third, are functions that take as input the video, audio and subsidiary metadata events communicated from Metadata Repository Service 604 and compare those events with user generated input events. An example of such comparison functions is for scoring in a computer game where the user is scored on generating input that matches or synchronizes with the metadata events of the video. Such comparisons might measure, for example, the accuracy of the user's input in matching mctadata events, or the user's reaction time in responding to metadata events.

Fourth, are functions that alter or determine the video or audio presentation parameters of the Pre-recorded Video Media Content 612 based on the outputs of the comparison functions, so that any of the presentation characteristics of the video, for example, such as chrominance, luminance, contrast, volume frequency spectrum, etc. can be altered to change the user's experience based on their response to the metadata events. In regard to this category of functions, it must be recognized that there are a limited number of presentation characteristics that can be altered because of the loosely-coupled architecture of the present invention, typically characteristics that might be altered by a user independently experiencing the media stream. Technically, suppliers of Video Media Content Services often provide an Application Program Interface that provides access to the features of the video media which they allow to be altered in playback.

Looking at FIG. 6 from the perspective of delivery as opposed to creation of a skill-enhancing application based on pre-recorded video media content, an end user desiring to use an application created by the methods described above would initiate a request for the application based on a particular pre-recorded video media content instance to End-User Client Device Service 600, through User Input 630, typically by clicking on a link in an application screen or in a web page with a mouse or entering data from a keyboard. End-User Client Device Service 600, performs a number of functions running on an end-user computing device, that include media and game discovery, presentation of streaming media content, presentation of computer game content, synchronization of video media content and application content, comparison of user input events and actions with metadata events and scoring or success/failure feedback.

As will be clear to a practitioner of average skill in the art, End-User Client Device Service 600 may be implemented in a wide variety of ways. It can be implemented as an installable program on a variety of platforms (for instance, Microsoft Windows, Apple OSX, Linux). Using a variety of programming languages (for instance C, C++, C#, Java). It can be implemented as a downloadable executable running on a virtual machine on the client computing device using scripting languages such as for instance Flash/AS3, Python, PHP, JavaScript. Such choices are evident to the average practitioner and do not limit the generality of the present invention which could be implemented in any one or many of such programming forms.

A user's request for a skill-enhancing application to End-User Client Device Service 600 can be either direct or indirect. In the direct case, End-User Client Device Service 600 presents a choice of existing games to the user who selects one, generating an Existing Application Request 620. In the indirect case, a user may request an application relating to a particular piece of video media content or even explore available video media content to decide on a piece of content. The discovery functions of End-User Client Device Service 600 present options of available content to the user. When the user makes a choice of available content, the discovery functions search if the desired content has been analyzed by the Video Media Analysis Service 603 and if application Application Objects 625 and Metadata 626 are available. If such application components are available, an Existing Application Request 620 is generated. If no game components are available, a New Application Request 610 is sent to Application Coordination Service 610 which sends a New Application Video Media Request 611 to Video Media Content Service 602 which sends the Pre-Recorded Video Media Content 612 to Video Media Analysis Service 603, initiating the creation of a application according to the creation process described above.

In the case that application already exists, the End-User Client Device Service 600 sends an Existing Application Request 620 to Application Coordination Service 601 which in turn generates a Metadata Request 622 to Metadata Repository Service 604 and an Existing Application Video Media Request 621 to Video Media Content Service 602. In response to these requests, Video Media Content Service 602 sends Pre-Recorded Video Media Content 612 to End-User Client Device Service 600 and Metadata Repository Service 604 sends Metadata 626 to End-User Client Device Service 600. As well, Application Coordination Service 601 sends an Application Objects Request 623 to Application Objects Service 605 which sends Application Objects 625 to the End-user Client Device Service 600.

At this point, three sources of data have been delivered to End-User Client Device 600. They are, Pre-recorded Video Media Content 624, from the Video Media Content Service 602, Metadata 626 and Application Objects 625. Returning to the diagram of a loosely-coupled game using streaming media in FIG. 5, one can see that these are equivalent to the Media Presentation Data 531 from the Media Content Service 530 and the Application Logic and Content Metadata 521 and Synchronization Data 522 from the Application Data Service 605. A fourth source of data is the user's interactive input, User Control Data 504 in FIG. 5 and User Input 630 in FIG. 6. Taking these inputs, the End-User Client Device Service 600 operates substantially as described in FIG. 5 generating and rendering two separate presentation streams, the Media Presentation Data 531 and the Application Presentation Data 516. The two streams are Synchronized by the Synchronization Functions 513 based on Synchronization Data 522 which is derived in FIG. 6 from Metadata 626 and Application Objects 625. Thus we arrive at two independent sets of presentation objects, the Media Content Presentation 541 and the Interactive Content Presentation 542 that are perceptually integrated into an extended user experience by the Game Player without the necessity of modifying or storing the original pre-recorded Media stream.

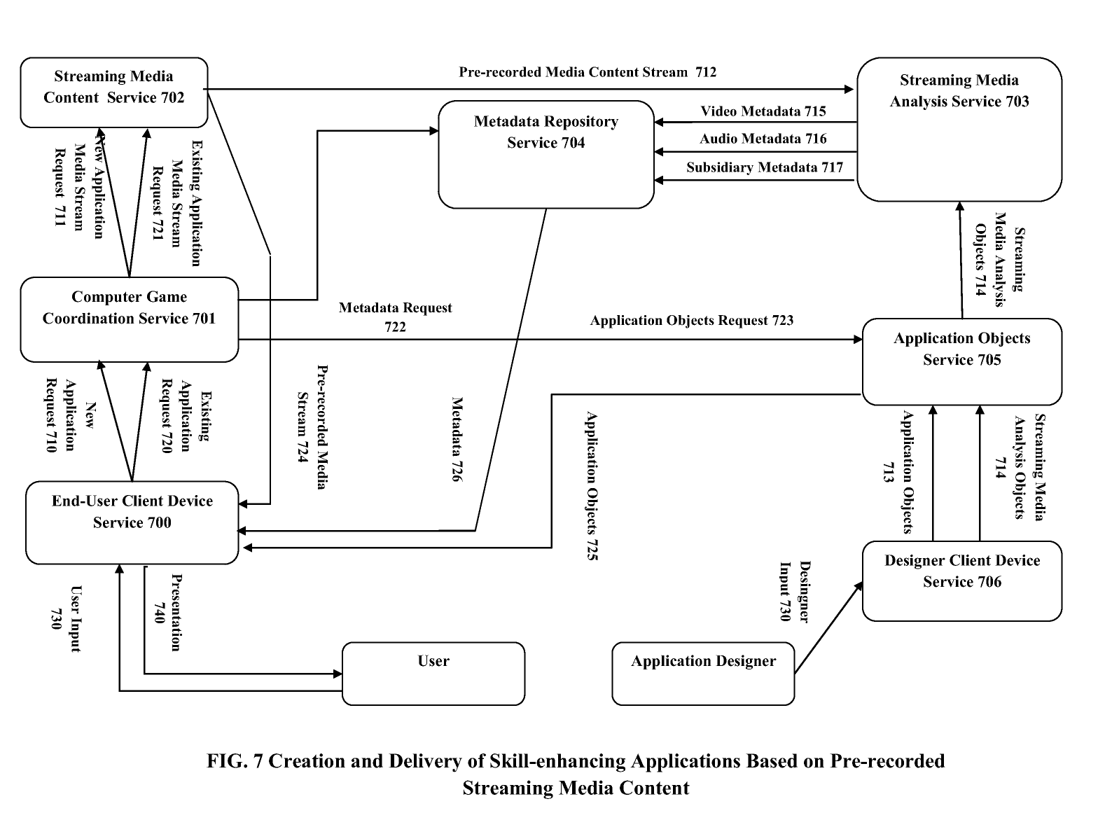

FIG. 7 presents a service-oriented architecture (SOA) diagram of a second general embodiment of the system structure and methods of the present invention by which creation and delivery of a skill-enhancing application is effected based on pre-recorded streaming media content. The first embodiment described in FIG. 6 focused on a particular type of content, video media content, excluding other types of media content such as audio. This second embodiment focuses not on media content type, but includes all types of media content, encompassing both video and audio. This embodiment focuses instead on the mechanisms of delivering the content, specifically limiting its scope to media content that is delivered as a stream from an external streaming media server over a network such as the internet.

The presentation of the system and methods of the present invention as a service architecture represents the fact that the invention may be embodied in numerous physical forms without altering the essential characteristics of the invention. For example, all of the services described in the diagram might execute on different server and client computers communicating on a wired or wireless local network or a wide area network such as the internet. Or, some mixture of services might execute on a single device and one or more other services might execute on other computing devices communicating on a network. A practitioner normally skilled in the art will perceive that the invention described is broadly independent of such variations in distribution of its functional components and that the descriptions provided are intended to include all possible combinations of computational devices and network variants. The specific exception to that generality of this second general embodiment is that the media content service is defined as a streaming media service and the streaming media service is provided from a server that is separate from the other system components, delivering the media over a local area network or wide area network such as the internet. Familiar examples of such streaming media services are services such as YouTube and Spotify.

Both automated and human-originated components are described. Preliminary to the automated process, one or more game designer/programmer(s) specify and produce executable functions that generate interactive objects that will execute in synchrony with the pre-recorded video media content to create a skill-enhancing application. In FIG. 7, the game designer/programmer(s) define and create two types of functions through Designer Client Device Service 706. The first type of functions is a set of functions, Streaming Media Analysis Objects 714, that are passed to the Application Objects Service 705 and on to Streaming Media Analysis Service 703. These functions are a set of analytical functions that extract different types of metadata indicative of the skill to be mastered from the pre-recorded streaming media content. Media Analysis Service 703 executes these functions on Pre-recorded Media Content Stream 712 and outputs categorized events Video Metadata 715, Audio Metadata 716 and Subsidiary Metadata 717 to Metadata Repository Service 704, where they are stored until retrieved for execution of the skill-enhancing application by the end user.

A practitioner normally schooled in the art will recognize that the media analysis could be performed on any type of linear media stream (for instance an audio stream) and the focus on a video stream in this example is chosen because it is a more complex case which may include multiple media sub-streams, including audio and other data types. The field of both audio and video analysis has an extensive history and literature within the field of signal processing, pattern matching and filtering. Optionally, the extracted features, patterns and events may be transformed into other forms or combined to generate audio and video metadata that is more useful as data for constructing the application from the pre-recorded media stream.

The Subsidiary Metadata 717 is derived from a wide variety of data that may optionally be present in the pre-recorded media stream (for example, subtitles, close captioning, author and rights information). An essential type of Subsidiary Metadata is a time representation to which the audio, video, audio metadata, video metadata, and other subsidiary metadata may be synchronized to the Pre-Recorded Media Content Stream 712 as previously described in FIG. 5, Synchronizing Functions 513 and Synchronization Data 522. The metadata that is extracted, processed and stored is specific to the individual skill-enhancing application. Description of the details of the metadata analysis performed in Streaming Media Analysis Service 703 will be described in more detail in relation to the representative skill-enhancing applications described in FIGS. 8 to 15. The essential general characteristic that distinguishes Streaming Media Analysis Service 703 from Video Media Analysis Service 603 described in FIG. 6 is that streaming media analysis must be performed in real time as the media stream is received, whereas Video Media Analysis Service 603 is not constrained to operate in real time on stream data, but could also operate on files or database records downloaded to the analysis service.

As described in FIG. 5, it is a feature of the loosely-coupled architecture of the present invention that Pre-recorded Media Content Stream 712 is substantially independent of the other components of the system. Thus, the game designer and provider has many choices as to the location and communication between the other services of the system such as Streaming Media Analysis Service 703, Application Objects Service 705, Metadata Repository Service 704, Application Coordination Service 701 and Designer Client Device Service 706, but the Streaming Media Content Service 702 is kept separate because it most likely will be a service of an independent party providing streaming media services accessible to the public such as YouTube, Spotify, LaLa and many others.

Video Metadata 715, Audio Metadata 716 and Subsidiary Metadata 717 are stored in Metadata Repository Service 704, but Pre-recorded Media Content Stream 712 is not stored in the application system at all because in many cases the providers of streaming media services are constrained by copyright and media usage rights constraints which allow free use of the content as a stream, but prohibit modification or storage of the content. It is thus important in such cases that the Pre-recorded Media Content Stream 712 is used only to generate descriptive metadata and not modified or stored in the system. Thus it is assumed in the present invention that Pre-recorded Media Content Stream 712 is provided from a Streaming Media Content Service 702 that is external to the other parts of the loosely-coupled skill-enhancing application generated from it. In such case, the application uses the Pre-recorded Media Content Stream 712 exactly as provided by the external Streaming Media Content Service 702 without making any change to it or storing any copy of it.

The second type of functions created by the application designer/programmer through Designer Client Device Service 706 are Application Objects 713 which extend the user's experience of the pre-recorded media stream as it is played, without modifying the pre-recorded media stream data itself and which define the application responses to end-user inputs. Application Objects 713 include four categories of functions.

First, are functions that add to the graphical or auditory experience of the pre-recorded media stream. For example, such functions might overlay explanatory text, graphics, or animations, or add audio voice or music overlays to the independent pre-recorded streaming media. Second, are functions that add interfaces for human interaction with the application. The functions and interfaces envisaged in the present invention are oriented to providing a framework for user interaction with the type of skill-enhancing application being created and support a broad range of input peripherals, including any peripheral device that can communicate with the End User Client Device Service 700 to provide User Input 730, for example, wired or wireless pointing devices, keyboards, joysticks, graphic tablets, mobile phones and other mobile devices, special purpose devices related to specific input/output styles such as the simulated game artifacts or musical instruments used for music games on game consoles, and actual independent electronic special purpose devices incorporating computer data or control interfaces, such as, for example, any electronic musical instrument that incorporates a MIDI interface.

Third, are functions that take as input the video, audio and subsidiary metadata events communicated from Metadata Repository Service 704 and compare those events with user generated input events. An example of such comparison functions is for scoring in an application where the user is scored on generating input that matches or synchronizes with the metadata events of the media stream. Such comparisons might measure, for example, the accuracy of the user's input in matching metadata events, or the user's reaction time in responding to metadata events. Fourth, are functions that alter or determine the video or audio presentation parameters of the Pre-recorded Media Content Stream 712 based on the outputs of the comparison functions, so that any of the presentation characteristics of the video or audio, for example, such as chrominance, luminance, contrast, volume frequency spectrum, etc. can be altered to change the user's experience based on their response to the metadata events. In regard to this category of functions, it must be recognized that there are a limited number of presentation characteristics that can be altered because of the loosely-coupled architecture of the present invention, typically characteristics that might be altered by a user independently experiencing the media stream. Technically, suppliers of Streaming Media Content Services often provide an Application Program Interface that provides access to the features of the media stream which they allow to be altered in playback.

Looking at FIG. 7 from the perspective of delivery as opposed to creation of a skill-enhancing application based on pre-recorded media content streams, an end user desiring to play an application created by the methods described above would initiate a request for an application based on a particular pre-recorded media stream to End-User Client Device Service 700, through User Input 730, typically by clicking on a link in a web page with a mouse or entering data from a keyboard. End-User Client Device Service 700, performs a number of functions running on an end-user computing device, that include media and game discovery, presentation of streaming media content, presentation of computer game content, synchronization of streaming media and application content, comparison of user input events and actions with metadata events and scoring or success/failure feedback. As will be clear to a practitioner of average skill in the art, End-User Client Device Service 700 may be implemented in a wide variety of ways. It can be implemented as an installable program on a variety of platforms (for instance, Microsoft Windows, Apple OSX, Linux). Using a variety of programming languages (for instance C, C++, C#, Java). It can be implemented as a downloadable executable running on a virtual machine on the client computing device using scripting languages such as for instance Flash/AS3, Python, PHP, or JavaScript. Such choices are evident to the average practitioner and do not limit the generality of the present invention which could be implemented in any one or many of such programming forms.

A user's request for a skill-enhancing application to End-User Client Device Service 700 can be either direct or indirect. In the direct case, End-User Client Device Service 700 presents a choice of existing applications to the user who selects one, generating an Existing Application Request 720. In the indirect case, a user may request a game relating to a particular piece of streaming media content or even explore available streaming media content to decide on a piece of content. The discovery functions of End-User Client Device Service 700 present options of available content to the user. When the user makes, a choice of available content, the discovery functions search if the desired content has been analyzed by the Streaming Media Analysis Service 703 and if computer game Application Objects 713 and Metadata 726 are available. If such game components are available, an Existing Application Request 720 is generated. If no game components are available, a New Application Request 710 is sent to Application Coordination Service 710 which sends a New Application Media Stream Request 711 to Streaming Media Content Service 702 which sends the Pre-Recorded Media Content Stream 712 to Streaming Media Analysis Service 703, initiating the creation of a new application according to the creation process described above.

In the case that the application already exists, the End-User Client Device Service 700 sends an Existing Application Request 720 to Application Coordination Service 701 which in turn generates a Metadata Request 722 to Metadata Repository Service 704 and an Existing Application Media Stream Request 721 to Streaming Media Content Service 702. In response to these requests, Streaming Media Content Service 702 sends Pre-Recorded Media Content Stream 712 to End-User Client Device Service 700 and Metadata Repository Service 704 sends Metadata 726 to End-User Client Device Service 700. As well, Application Coordination Service 701 sends an Application Objects Request 723 to Application Objects Service 705 which sends Application Objects 725 to the End-user Client Device Service 700.

At this point, three sources of data have been delivered to End-User Client Device 700. They are, Pre-recorded Media Stream 724, from the independent Streaming Media Content Service 702, and Metadata 726 and Application Objects 725. In this second embodiment, it should be noted that Pre-recorded Media Stream 724 differs from the other data sources in that it is delivered as a stream of media data that must be responded to in real time, whereas the other data Metadata 726 and Application Objects 725 may be delivered in file, record or any other convenient format. Returning to the diagram of a loosely-coupled game using streaming media in FIG. 5, one can see that these are equivalent to the Media Presentation Data 531 from the Media Content Service 530 and the Application Logic and Content Metadata 521 and Synchronization Data 522 from the Application Data Service 520.

A fourth source of data is the user's interactive input, User Control Data 504 in FIG. 5 and User Input 730 in FIG. 7. Taking these inputs, the End-User Client Device Service 700 operates substantially as described in FIG. 5 generating and rendering two separate presentation streams, the Media Presentation Data 531 and the Application Presentation Data 516. The two streams are synchronized by the Synchronizing Functions 513 based on Synchronization Data 522 which is derived in FIG. 7 from Metadata 726 and Application Objects 725. Thus we arrive at two independent sets of presentation objects, the Media Content Presentation 541 and the Interactive Content Presentation 542 that are perceptually integrated into an extended user experience by the user without the necessity of modifying or storing the original pre-recorded Media stream.

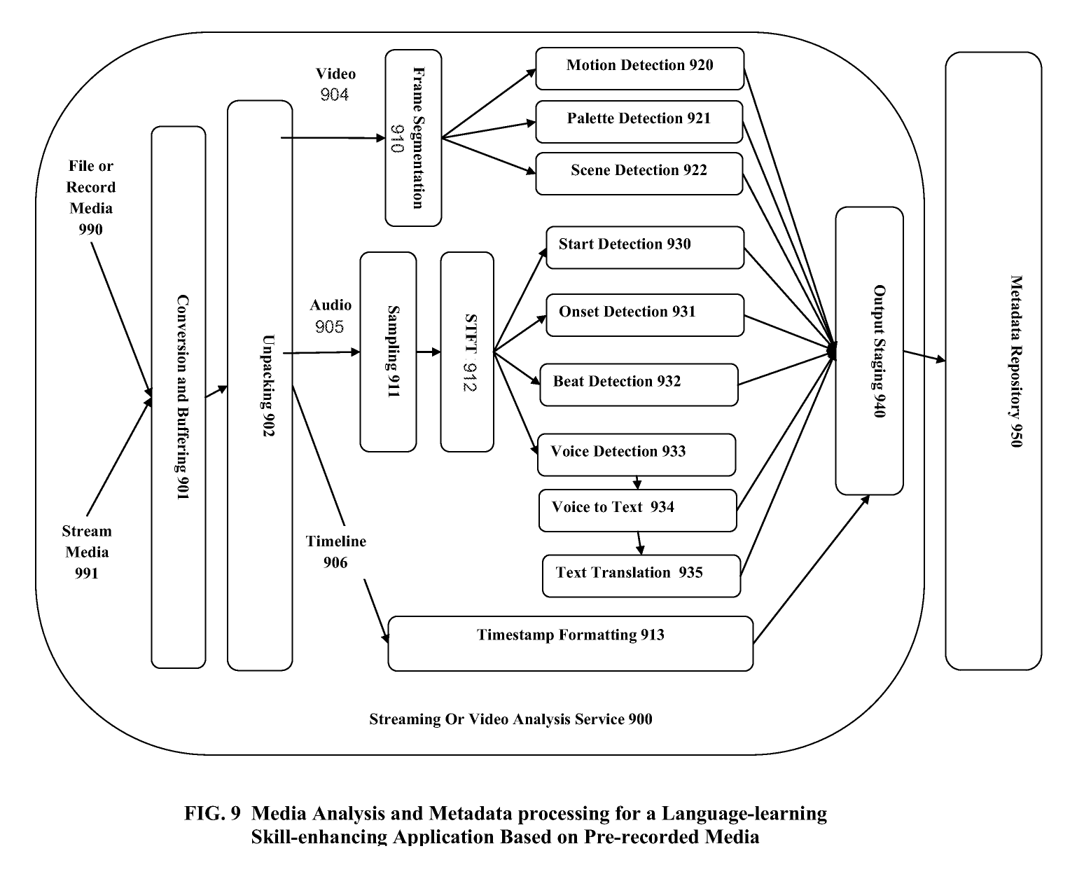

The game creation and distribution systems and methods described generally in FIGS. 6 and 7 may be used to generate a great diversity of loosely-coupled distributed, parallel skill-enhancing applications. FIGS. 8,10,12 and 14 describe a small number of the possible skill-enhancing applications of the current invention. FIGS. 9,11, 13 and 15 describe the media analysis and metadata extraction and processing functions associated with the applications. A practitioner of average skill in the art will recognize that there are many other skill-enhancing applications that could be created using the current invention and that the examples described are merely illustrative of the diversity of skill-enhancing applications that may be created, distributed and played according to the current invention.

FIG. 8 describes an illustrative embodiment of the current invention, a loosely-coupled language-learning skill-enhancing application based on pre-recorded media. This example application could be implemented according to the methods of either the first embodiment of the present invention described in FIG. 6 or the second embodiment described in FIG. 7. Since the methods are similar and one may be inferred from the other given the detailed descriptions above, we will describe only the variant relating to streaming media described in FIG. 7.

A well-known barrier to learning a new language is the difficulty learners have in segmenting spoken phrases into individual words. Sentences in a new unfamiliar language tend to be perceived as a continuous stream of sound with no evident pauses or demarcation to indicate the individual word meaning units. It is very difficult for learners to gain enough experience of a new language to train their perception to segment phrases into word meaning units. The described computer game allows learners to practice such segmentation and evaluate their progress by interacting with a great variety of online media streamed from widely accessible streaming media sites. FIG. 8 will describe a specific illustrative example of the general descriptions set out in FIGS. 5, 6 and FIG. 7. FIG. 8 shows the elements of the user's view of such a loosely-coupled application as it might appear on the user's display device, Presentation Device 840, which is represented as Media Presentation Device 540 in FIG. 5. Within the Presentation Device are two types of presentation objects, the Game Interactive Content Presentation Elements 842a, 842b, 842c and 842d corresponding to Game interactive Content Presentation 542 in FIG. 5 and Media Content Presentation 841 corresponding to Media Content Presentation 541 in FIG. 5.

The Media Content Presentation 841 may be any accessible pre-recorded media content that includes spoken or sung speech in the language the player wishes to learn. In the illustration FIG. 7 the media content stream is assumed to include speech in English and the player is assumed to be a Spanish-speaking person wishing to learn English. As the media content stream is presented to the player, the Application. Interactive Content Presentation Element 842b presents an English caption transcription of the words spoken in the media content stream. Application Interactive Content Presentation Element 842c presents a Spanish translation caption of the English words spoken. The Application Interactive Content Presentation Element 842d is an animated “bouncing ball” that advances from word to word over the English transcription as the player presses a key on his or her input device. The task of the player is to coordinate the movement of the bouncing ball element to the spoken words so that the movement of the ball is synchronous with the speech in the media content stream. The Spanish translation caption line provides a subsidiary information channel to the player so he or she can correlate the sound of the English words with their meaning in a familiar language. The Application Interactive Content Presentation Element 842a shows the player a measure of their success in synchronizing the ball movement to the words in the Media Content Presentation 841.

We can see how this illustrative computer game would be created and distributed by reference to FIG. 7. There, a New Application Media Stream Request 710 would be generated to the Streaming Media Content Service 702 which would send Pre-recorded Media Content Stream 712 to the Streaming Media Analysis Service 703. Streaming Media Analysis Objects 714, giving the analysis requirements for this class of media content (which will be described in more detail in FIG. 9) to Streaming Media Analysis Service 703 which would analyze the media content audio, performing a voice to text conversion function resulting in English text caption metadata. The English text caption metadata would be processed by an English to Spanish translation function and the two caption streams would be transferred as Audio Metadata 716 to Metadata Repository Service 704. In parallel, the video content would be analyzed and transferred as Video Metadata 715 and the timeline of the streaming media content and the timestamps of the converted captions would be extracted and transferred to Metadata Repository Service 704 as Subsidiary Metadata 717.

As well as Streaming Media Analysis Objects 714, the Game Designer would provide Application Objects 713 that provide functions in Application Objects Service 705 to render the caption content on the player's presentation device and to compare the player's input device key presses to the timing of the English speech caption metadata, score success or failure and render the player's score in a score presentation object.

Having created the metadata for the media content stream, the application is ready for delivery and play. A player wishing to play the language learning game relative to the media content requests the game through End-User Client Device Service 700, generating now an Existing Application Request 720 to Application Coordination Service 701 which generates three different requests, Existing Application Media Request 721 to Streaming Media Content Service 702, Metadata Request 722 to Metadata Repository Service 704 and Application Objects Request 723 to Application Objects Service 705. The Streaming Media Content Service 702 returns the Pre-recorded Media Content Stream 724 to the End-User Client Device Service 700, more particularly, to the Media Player 514 and hence to the Media Content Presentation 541 in the Media Presentation Device 540 in FIG. 5. The Metadata Repository Service 704 returns the Metadata 726 and the Application Objects Service 705 returns the Application Objects 725 to the End-User Client Device Service 700, more particularly to the Game Logic 512 and Synchronizing Functions 513 which deliver the Application Presentation Data 516 to the Application Interactive Content Renderer 515 under control of User Control Data 504 generating the Interactive Content Presentation 542 on the player's Media Presentation Device 540.

FIG. 9 is a diagram providing a more detailed representation of the metadata extraction and processing service of the representative language-learning representative embodiment of the present invention described in FIG. 8 above. The descriptions of FIG. 9 apply to the two general embodiments of the present invention described in FIG. 6 and FIG. 7. In FIG. 9 the input of File or Record Media 990 into Conversion and Buffering 901 of Streaming Media or Video Media Analysis Service 900 is equivalent to the input Pre-recorded Video Media Content 612 into Video Media Analysis Service 603 in FIG. 6 or the Pre-recorded Media Content Stream 712 into Streaming Media Analysis Service 703 in FIG. 7.

To simplify processing, File or Record Media 990 and Stream Media 991 are converted into a common format temporary data structure in Conversion and Buffering 901 where they may be accessed by the various analytical functions. Next, the function Unpacking 902 removes the media data contents from the media container and separates the media into video content, Video 904, audio content, Audio 905 and time synchronization content, Timeline 906.

Video 904 is passed to Frame Segmentation 910 where it is divided into individual frame data for processing in the signal pattern analysis stage Motion Detection 920, Palette Detection 921 and Scene Detection 922. Motion events and repetitive motion patterns are useful indicators of language events when correlated to detected audio events and patterns. The techniques of video motion detection are well known, with an extensive literature. Software for performing motion detection is available from multiple commercial and open source projects, described, for instance at The Code Project online at http://www.codeproject.com/KB/audio-video/Motion_Detection.aspx by Andrew Kirillov. Detection of the dominant color palette of video frames, changes in dominant color palette and repetitive sequences of color palette changes are indicative of language events when correlated to detected audio events and patterns. As well, the dominant color palette of the media content is useful in constructing the interactive application presentation objects where it may be used to set the color of the backgrounds and presentation objects so that they appear to be a part of the media content presentation even though the media content presentation is independent of the interactive objects.

The techniques of detecting the dominant color palette of video frames are well known in relation to the field of video compression where the dominant color distribution is used set up efficient code tables for maximal compression efficiency. A simple color palette detection function may be constructed by sampling the video pixel color at regular intervals and ordering the results to show the highest rates of repeated colors. Scene detection is a useful indicator of significant events in the video stream and scene change events that correlate with other audio events and patterns are often useful indicators of language.

Scene detection software is used extensively in video editing to automatically divide raw video footage into clips for ease of editing. Scene detection software is widely available from commercial vendors, for example HandySaw from Davis Software. As well, the underlying technology is used in video compression techniques to establish points at which a new compression redundancy lookup table should be instantiated. This is based on the fact that scene changes are typically transition points that introduce a different mix of visual artifacts that require a different code table for maximal compression. The extracted metadata events and patterns from Motion Detection 920, Palette Detection 921 and Scene Detection 922 are passed to Output Staging 940 for correlation with other metadata events and patterns and formatting for transfer to Metadata Repository 950.

Audio 905 is passed to Sampling 911 where the native samples of the source audio are sub-sampled into a number of discrete sample windows to facilitate further processing. The samples are passed to STFT 912 where a Short-Time Fourier Transform (STFT) is performed. The short-time Fourier transform (STFT), or alternatively short-term Fourier transform, is a function used to determine the sinusoidal frequency and phase content of local sections of a signal as it changes over time. The Fourier Transform is well known to signal processing practitioners. The STFT is widely used in music analysis. References to many of the signal processing functions described in this section may be found in the proceedings of The International Society for Music Information Retrieval (ISMIR, http://ismir.net/).

The output spectrum analysis of the STFT is passed to a bank of detection functions to extract specific events and patterns in the audio that are useful indicators of voice patterns. It should be noted that the data presented by Audio 905 is not just voice data. Large amounts of the data may not be voice at all, but silence, clapping, cheering and various types of noise. Thus, the central task of the detection functions is to differentiate voice metadata from other types of audio in the signal. Start Detection 930 detects the start of the audio signal and reconciles the start of the audio with the start of the video for synchronization purposes. It distinguishes the start of the audio from the start of signals since the start of an audio track may have a lead period of digital silence.

After a start of signal is differentiated from a start of audio track, the audio phenomena are categorized to differentiate silence, clapping and noise and other extraneous artifacts from the voice content. Several technologies may be applied in this process, including silence filtering using the program Sox (http://sox.sourceforge.net) and voiced/unvoiced detection (see Li, Yipeng; Wang, DeLiang Singing Voice Separation from Monaural Recordings ISMIR 2006 Proceedings). Start Detection 930 uses the same techniques to detect pauses within the voice content in the audio data and the end of the voice content in the audio data. Some of the non-music events such as clapping, cheering and whistling may be retained as metadata indicative of the points of importance within the voice data. In the case that the media content is music with song or narration voice content, Beat Detection 932, and Voice Detection 933 are functions that differentiate musical events and patterns from within a polyphonic audio signal. Beat Detection 932 acts to create a pattern of events that indicate appropriate time to synchronize voice sound events.

There is extensive literature on this type of processing. See, for instance, Simon Dixon (http://www.elec.qmul.ac.uk/people/simond/pub/2007/jnmr07.pdf), Evaluation of the Audio Beat Tracking System BeatRoot, Journal of New Music Research, 36 (1), 39-50, 2007. Voice Detection 933 separates human voice events from other musical and audio events. As already noted in description of Start Detection 930, voice detection is also used to differentiate non-musical voice events such as introductions and narrations from musical events such as singing. As the various musical and non-musical artifacts are detected, Onset Detection 931 detects the precise onset and end of each detected event, again with techniques well known to practitioners of the art, for instance, the OnsetsDS Library by Dan Stowell (see http://onsetsds.sourceforge.net/) and You, Wei; Dannenberg, Roger B. Polyphonic Music Note Onset Detection Using Semi-Supervised Learning ISMIR 2007.

The extracted metadata events and patterns from Start Detection 930, Onset Detection 931, Beat Detection 932 are passed to Output Staging 940 for correlation with other metadata events and patterns and formatting for transfer to Metadata Repository 950. The extracted metadata and events from Voice Detection 933 are passed to Voice to Text 934 where the audio signal is analyzed and converted to text. The techniques of Speech Recognition are well known to practitioners of the art and there are many sources of speech recognition software from commercial vendors such as IBM, Kurzweil Applied Intelligence and Dragon Systems and open source projects such as the Carnegie Mellon University SPHYNX project. The converted voice data is passed to Output Staging 940 for correlation with other metadata events and patterns and formatting for transfer to Metadata Repository 950 and as well to Text Translation 935 for translation to the user's native language so that the text from Voice to Text 934, which is in the language the user is learning, may be given meaning context in the user's native language. The techniques of automated language translation are well known to practitioners of the art and there are many sources software and online services such as Google Translate from Google as well as numerous open university projects. The output of Text Translation 935 is passed to Output Staging 940 for correlation with other metadata events and patterns and formatting for transfer to Metadata Repository 950.

The process of media analysis and metadata extraction described in FIG. 9 could be effected with alternative combinations of software, some of which are capable of extracting voice from video and converting it to caption text in a single pass. Such software is available in Adobe Premiere Pro CS4 and Soundbooth from Adobe Systems and used in several online video search engines such as YouTube from Google. Such systems may have limited effectiveness in the presence of audio noise or other artifacts, so the more detailed approach described in FIG. 9 is presented to acknowledge that there are multiple possible methods of extracting the necessary metadata for the representative embodiment of the current invention described in FIG. 8.

Timeline 906 is passed to Timestamp Formatting 913 where the native timecode of the source media is normalized to a format that assures the audio, video content and the various classes of extracted metadata events and patterns are compatible and synchronizable with each other. The timeline data is passed to Output Staging 940 where it is used as a synchronization reference as the various metadata events and patterns are assigned to categories associated with specific user inputs.

Output Staging 940 sorts the metadata events and patterns and associates them with specific application presentation objects before passing the consolidated metadata with timeline synchronization data to Metadata Repository 950. This association falls into two general categories—Skill Modeling and Presentation Enhancement. One simple example of Skill Modeling is the association of the text metadata extracted from voice events with the captioning objects that represent them to the user. For instance, a specific combination of Beat Detection 932 output metadata events with Voice Detection 933, Voice to Text 934 and Onset Detection 931 and Motion Detection 920 output metadata events might be assigned to an association with a text object in the upper caption line of Application Interactive Content Presentation Element 842b in FIG. 8.

The output of the Text Translation 935 over an aggregate of a number of output tokens from Voice To Text 934 would be assigned to Interactive Content Presentation Element 842c representing the meaning of the voice tokens in the user's native language. Thus the metadata provide a model of the voice/language structure as it is presented in the media content which is visualized through the associated Application Interactive Content Presentation Elements. The user attempts to synchronize his or her input gestures with the visualized model by clicking with keyboard or mouse to move the indicator of the word onsets of the voice in sync with the media. User input is compared with the model and scored. The score feedback allows the user to progressively converge on the model by repetitive practice, the net result being the progressive enhancement of the skill of hearing the segmented words in the language the user is learning.

A simple example of Presentation Enhancement is the association of extracted music events with the application objects that control non-skill related elements of the application presentation objects. For instance, the dominant color derived from Palette Detection 921 metadata events could be associated with the application presentation object driving the application text captioning color. Thus, the application captioning color could be forced to change to a color in contrast to video content, allowing greater readability and the illusion that the application is closely coupled to the media content.

From these examples one may see that Output Staging 940 is a type of rule-based system where combinations of categorized detected video and audio events are associated with application presentation objects. After execution of the desired rule set, the aggregated metadata and application object associations are transferred to Metadata Repository 950 from which they are retrieved to be combined with the media content and the application objects when the application is requested by the user as set out in FIGS. 6 and 7. The consolidated metadata records may be formatted in a variety of ways that are not central to the essence of the present invention. One format which is useful for ease of transfer between services over a network is the JavaScript Object Notation (JSON), a lightweight data-interchange format (see http://json.org/), however, it will be evident to a practitioner of average skill in the art that there are many choices, of data format and specific programming styles for the functions described in FIG. 9 and that the present invention could evidently be implemented in many such forms.

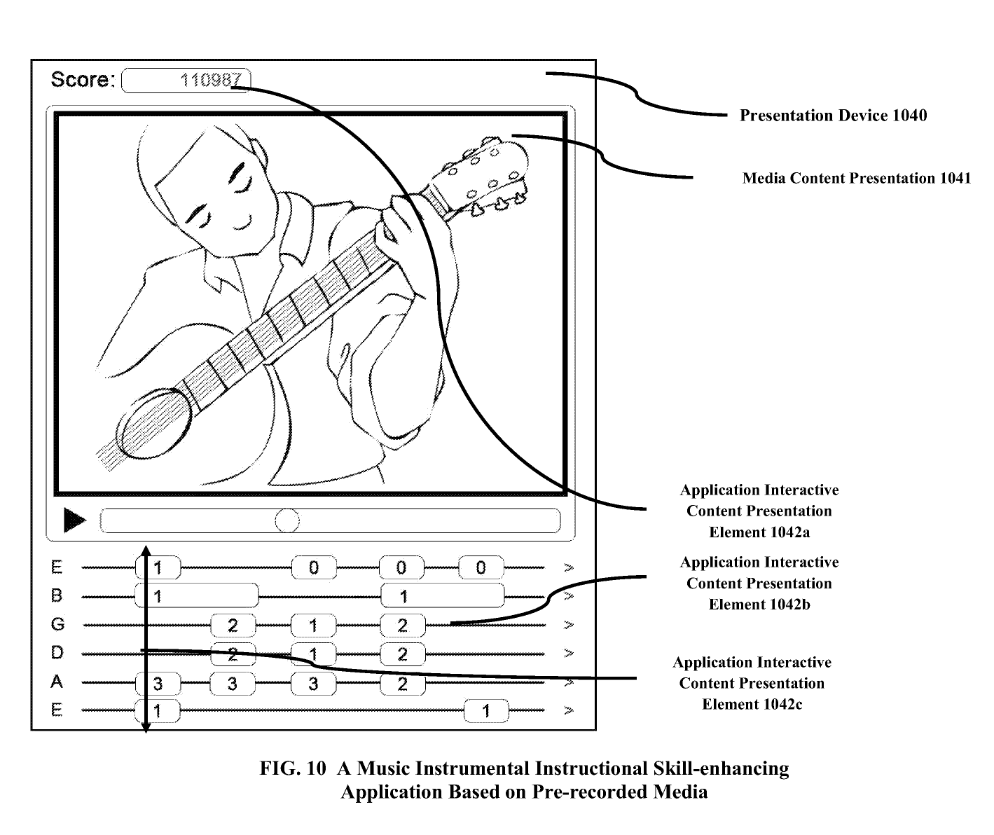

FIG. 10 describes an illustrative embodiment of the current invention, a loosely-coupled music instrumental instructional skill-enhancing application based on pre-recorded media. A well-known barrier to learning to play an instrument such as the guitar is the lack of adequate feedback to refine skills and technique while learning. With the emergence of such new streaming media services such as YouTube, students have a source for viewing accomplished players with a view to imitating their techniques. Some teachers even post instruction videos for learners. However, the key gap is that the existing media content is non-interactive and students have no adequate feedback to assess the success of their efforts to imitate the available media examples. The described skill-enhancing application allows learners to “play along” to a great variety of online media streamed from widely accessible streaming media sites in a game format that scores their success in imitating the techniques presented in the media content. The media content may be from available pre-recorded performances or from pre-recorded instructional videos.

FIG. 10 will be described as a specific illustrative example of the general descriptions set out in FIG. 5 and FIGS. 7 and 6. FIG. 10 shows the elements of the player's view of such a loosely-coupled game as it might appear on the player's display, presented as Media Presentation Device 540 in FIG. 5. Within the Presentation Device are two types of presentation object, the Application Interactive Content Presentation Elements 1042a, 1042b and 1042c, corresponding to Interactive Content Presentation 542 in FIG. 5 and Media Content Presentation 1041 corresponding to Media Content Presentation 541 in FIG. 5.

The Media Content Presentation 1041 may be any accessible pre-recorded media content that includes instrumental techniques the player wishes to learn. In the illustration in FIG. 10 the media content stream is assumed to include guitar music content containing techniques that the player wishes to learn. The guitar media content is presented in the Media Content Presentation 1041 area of the Presentation Device 1040. As the media content stream is presented to the player, the Application Interactive Content Presentation Element 1042b presents an animated guitar tablature representation of the music that is being played in the media content.

Tablature is a traditional representation of guitar music which shows the six strings of a guitar, the highest E string at the top, then decending to the B, G, D, A and finally the low E bottom string. On this representation of the guitar strings, the successive notes to be played are represented from left to right as blocks enclosing numbers. The length of the note is represented by the width of the block and the number of the guitar fret against which the player must press the string to create the desired pitch is represented by the enclosed number, 0 representing an open string with no fret pressed and the numbers 1 to 12 representing successive frets from the top of the guitar neck down. The note blocks move from right to left along the strings, with the position of the current note being played in the media content stream represented by the vertical line Application Interactive Content Presentation Element 842c.

Referring back to FIG. 5, in this application one of the Input Device(s) 502 is an actual guitar to be played by the learner. This guitar might be interfaced to the PC or Game Console 510 in a variety of ways. For the purpose of this description we will assume that the guitar includes an interface that is compatible to the PC or Video Game Console 510 according to the MIDI interface specification. The task of the player is to play the guitar Input Device according to the tablature notation so that each note is fingered on the designated string and fret as the note representation crosses the current time line, Application Interactive Content Presentation Element 1042c. The Game Interactive Content Presentation Element 1042a shows the player a measure of this or her success in synchronizing the note fingering with the video Media Content Presentation 1041.

We can see how this illustrative computer game would be created and distributed by reference to FIG. 7. There, a New Application Media Request 710 would be generated to the Streaming Media Content Service 702 which would send Pre-recorded Media Content Stream 712 to the Streaming Media Analysis Service 703. From Streaming Media Analysis Specification 714 giving the analysis requirements for this class of media content, Streaming Media Analysis Service 703 would analyze the media content audio, converting the guitar notes in the audio to a MIDI representation and then to a tablature representation. The MIDI and tablature streams would be transferred as Audio Metadata 716 to Metadata Repository Service 704. In parallel, the timeline of the streaming media content and the timestamps of the converted tablature notations would be extracted and transferred to Metadata Repository Service 704 as Subsidiary Metadata 717.

As well as Streaming Media Analysis Specifications 713, the Game Designer would provide Event and Action Definitions 714 that provide functions in Application Definition Service 705 to render the tablature content on the players presentation device and to compare the player's guitar input device MIDI data to the timing of the media content MIDI metadata, score success or failure and render the player's score in a score presentation object.

Having created the metadata for the media content stream, the computer game is ready for delivery and play. A player wishing to play the guitar instrument instruction game relative to the media content requests the game through End-User Client Device Service 700, generating now an Existing Game Request 720 to Application Coordination Service 701 which generates three different requests, Existing Game Streaming Media Request 721 to Streaming Media Content Service 702, Metadata Request 722 to Metadata Repository Service 704 and Events and Actions Request 723 to Computer Game Definition Service 705. The Streaming Media Content Service 702 returns the Pre-recorded Media Stream 724 to the End-User Client Device Service 700, more particularly, to the Media Player 514 and hence to the Media Content Presentation 541 in the Media Presentation Device 540 in FIG. 5. The Metadata Repository Service 704 returns the Metadata 726 and the Application Definition Service 705 returns the Events and Actions Definitions 725 to the End-User Client Device Service 700, more particularly to the Game Logic 512 and Synchronizing Functions 513 which deliver the Game Presentation Data 516 to the Game Interactive Content Render 515 under control of User Control Data 504 generating the Interactive Content Presentation 542 on the player's Media Presentation Device 540.

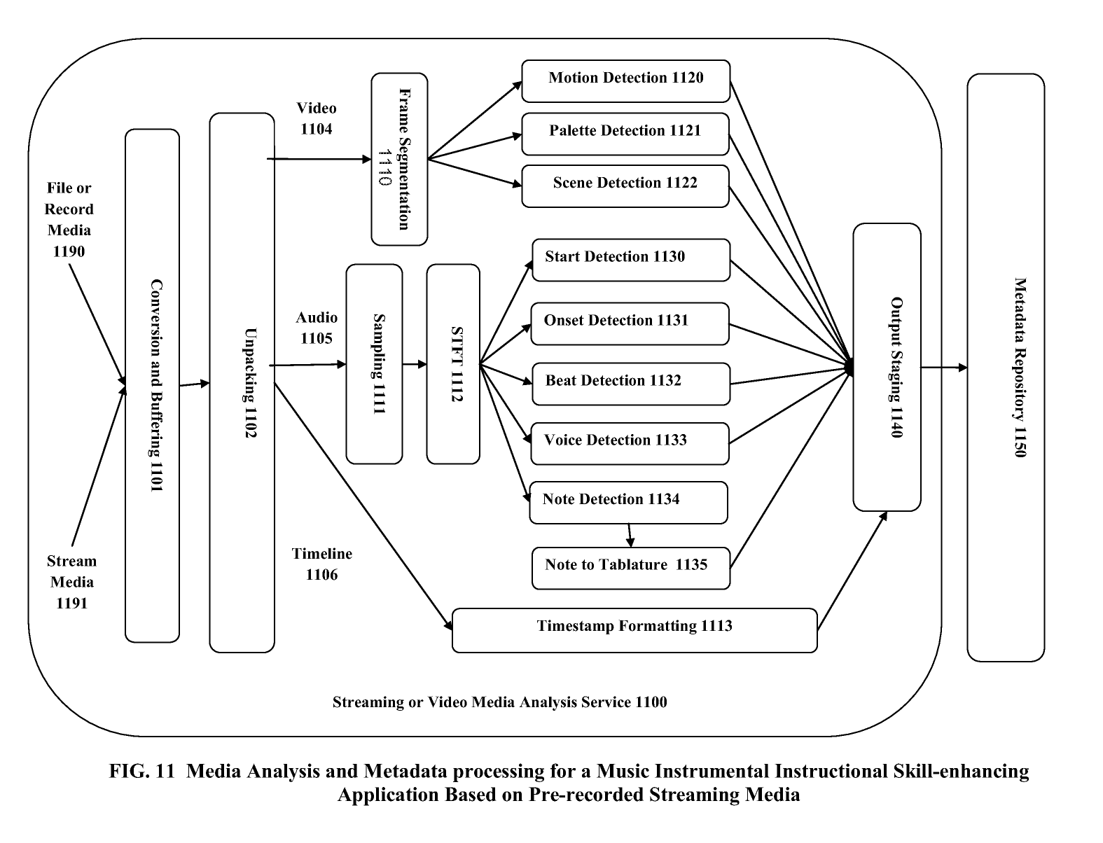

FIG. 11 is a diagram providing a more detailed representation of the metadata extraction and processing service of the representative music instrumental instruction skill-enhancing representative embodiment of the present invention described in FIG. 10 above. The descriptions of FIG. 10 apply to the two general embodiments of the present invention described in FIG. 6 and FIG. 7. In FIG. 11 the input of File or Record Media 1190 into Conversion and Buffering 1101 of Streaming Media or Video Media Analysis Service 1100 is equivalent to the input Pre-recorded Video Media Content 612 into Video Media Analysis Service 603 in FIG. 6 or the Pre-recorded Media Content Stream 712 into Streaming Media Analysis Service 703 in FIG. 7.

To simplify processing, File or Record Media 1190 and Stream Media 1191 are converted into a common format temporary data structure in Conversion and Buffering 1101 where they may be accessed by the various analytical functions. Next, the function Unpacking 1102 removes the media data contents from the media container and separates the media into video content, Video 1104, audio content, Audio 1105 and time synchronization content, Timeline 1106.

Video 1104 is passed to Frame Segmentation 1111 where it is divided into individual frame data for processing in the signal pattern analysis stage Motion Detection 1120, Palette Detection 1121 and Scene Detection 1122. Motion events and repetitive motion patterns are useful indicators of language events when correlated to detected audio events and patterns. The techniques of video motion detection are well known, with an extensive literature. Software for performing motion detection is available from multiple commercial and open source projects, described, for instance at The Code Project online at http://www.codeproject.com/KB/audio-video/Motion_Detection.aspx by Andrew Kirillov. Detection of the dominant color palette of video frames, changes in dominant color palette and repetitive sequences of color palette changes are indicative of language events when correlated to detected audio events and patterns. As well, the dominant color palette of the media content is useful in constructing the interactive application presentation objects where it may be used to set the color of the backgrounds and presentation objects so that they appear to be a part of the media content presentation even though the media content presentation is independent of the interactive objects.

The techniques of detecting the dominant color palette of video frames are well known in relation to the field of video compression where the dominant color distribution is used set up efficient code tables for maximal compression efficiency. A simple color palette detection function may be constructed by sampling the video pixel color at regular intervals and ordering the results to show the highest rates of repeated colors. Scene detection is a useful indicator of significant events in the video stream and scene change events that correlate with other audio events and patterns are often useful indicators of language. Scene detection software is used extensively in video editing to automatically divide raw video footage into clips for ease of editing. Scene detection software is widely available from commercial vendors, for example HandySaw from Davis Software. As well, the underlying technology is used in video compression techniques to establish points at which a new compression redundancy lookup table should be instantiated. This is based on the fact that scene changes are typically transition points that introduce a different mix of visual artifacts that require a different code table for maximal compression. The extracted metadata events and patterns from Motion Detection 1120, Palette Detection 1121 and Scene Detection 1122 are passed to Output Staging 1140 for correlation with other metadata events and patterns and formatting for transfer to Metadata Repository 1150.

Audio 1105 is passed to Sampling 1111 where the native samples of the source audio are sub-sampled into a number of discrete sample windows to facilitate further processing. The samples are passed to STFT 1112 where a Short-time Fourier Transform (SIFT) is performed. The short-time Fourier transform (SIFT), or alternatively short-term Fourier transform, is a function used to determine the sinusoidal frequency and phase content of local sections of a signal as it changes over time. The Fourier Transform is well known to signal processing practitioners. The SIFT is widely used in music analysis. References to many of the signal processing functions described in this section may be found in the proceedings of The International Society for Music Information Retrieval (ISMIR, http://ismir.net/). The output spectrum analysis of the SIFT is passed to a bank of detection functions to extract specific events and patterns in the audio that are useful indicators of voice patterns. It should be noted that the data presented by Audio 1105 is not just voice data. Large amounts of the data may not be voice at all, but silence, clapping, cheering and various types of noise. Thus, the central task of the detection functions is to differentiate voice metadata from other types of audio in the signal.

Start Detection 1130 detects the start of the audio signal and reconciles the start of the audio with the start of the video for synchronization purposes. It distinguishes the start of the audio from the start of signals since the start of an audio track may have a lead period of digital silence. After a start of signal is differentiated from a start of audio track, the audio phenomena are categorized to differentiate silence, narration, clapping and noise and other extraneous artifacts from the targeted instrumental music content. Several technologies may be applied in this process, including silence filtering using the program Sox (http://sox.sourceforge.net) and voiced/unvoiced detection (see Li, Yipeng; Wang, DeLiang Singing Voice Separation from Monaural Recordings ISMIR 2006 Proceedings). Start Detection 1130 uses the same techniques to detect pauses within the target instrumental music content in the audio data and the end of the music content in the audio data. Some of the non-music events such as clapping, cheering and whistling may be retained as metadata indicative of the points of importance within the instrumental music data. In the case that the media content is music with song or narration voice content, Beat Detection 1132, and Voice Detection 1133 are functions that differentiate musical events and patterns from within a polyphonic audio signal. Beat Detection 1132 acts to create a pattern of events that indicate appropriate time to synchronize music sound events. There is extensive literature on this type of processing. See, for instance, Simon Dixon (http://www.elec.qmul.ac.uk/people/simond/pub/2007/jnmr07.pdf), Evaluation of the Audio Beat Tracking System BeatRoot, Journal of New Music Research, 36 (1), 39-50, 2007.

Voice Detection 1133 separates human voice events from other musical and audio events. As already noted in description of Start Detection 1130, voice detection is also used to differentiate non-musical voice events such as introductions and narrations from musical events. As the various musical and non-musical artifacts are detected, Onset Detection 1131 detects the precise onset and end of each detected event, again with techniques well known to practitioners of the art, for instance, the OnsetsDS Library by Dan Stowell (see http://onsetsds.sourceforge.net/) and You, Wei; Dannenberg, Roger B. Polyphonic Music Note Onset Detection Using Semi-Supervised Learning ISMIR 2007.

The extracted metadata events and patterns from Start Detection 1130, Onset Detection 1131, Beat Detection 1132 and Voice Detection 1133 are passed to Output Staging 1140 for correlation with other metadata events and patterns and formatting for transfer to Metadata Repository 1150. The extracted metadata and events from Note Detection 1134 are passed to Note To Tablature 1135 where the instrumental music events are converted to a Tablature representation designating the guitar string and fret fingering that corresponds to the note. The techniques of Automated Music Transcription are well known to practitioners of the art and there are many sources of automated transcription software from commercial vendors such as Transcribe from Seventh String Software or iHearit from Trent Reschny or AudioScore from Avid Technologies Inc.

There are many alternative approaches to such conversion, including stepwise conversion through a standard intermediary representation such as MIDI. Such intermediate conversion software is available from commercial vendors such as Widisoft with their product WIDI 4.0. MIDI to Tablature representation software is available from vendors such as TablEdit.com. The output of Note to Tablature 1134 is passed to Output Staging 1140 for correlation with other metadata events and patterns and formatting for transfer to Metadata Repository 1150.

The process of media analysis and metadata extraction described in FIG. 11 could be effected with alternative combinations of software, some of which are capable of extracting audio from video and converting it to music score representation such as Tablature in a single pass. However, such systems may have limited effectiveness in the presence of audio noise or other artifacts, so the more detailed approach described in FIG. 11 is presented to acknowledge that there are multiple possible methods of extracting the necessary metadata for the representative embodiment of the current invention described in FIG. 10.

Timeline 1106 is passed to Timestamp Formatting 1113 where the native timecode of the source media is normalized to a format that assures the audio, video content and the various classes of extracted metadata events and patterns are compatible and synchronizable with each other. The timeline data is passed to Output Staging 1140 where it is used as a synchronization reference as the various metadata events and patterns are assigned to categories associated with specific user inputs.

Output Staging 1140 sorts the metadata events and patterns and associates them with specific application presentation objects before passing the consolidated metadata with timeline synchronization data to Metadata Repository 1150. This association falls into two general categories—Skill Modeling and Presentation Enhancement. One simple example of Skill Modeling is the association of the text metadata extracted from voice events with the captioning objects that represent them to the user. For instance, a specific combination of Beat Detection 1132 output metadata events with Note Detection 1134 and Onset Detection 1131 and Motion Detection 1120 output metadata events might be assigned to an association with the Tablature representation in the Application Interactive Content Presentation Element 842b in FIG. 10 providing a visual model of the instrumental music in the media content through the associated Application Interactive Content Presentation Elements. The user attempts to synchronize his or her guitar fingering with the visualized model by playing a guitar interfaced with the computer presenting the application.

The music input from the guitar is converted to a form compatible with the metadata format by the input processing of the application. Such conversion follows essentially the same technical process as described above. However this processing is much simpler than the processing of the media content because the guitar is directly connected to the application and processing does not have to account for noise and extraneous signals. If the user is using a guitar with MIDI output, the conversion is further simplified because the MIDI input format includes overt information about note, onsets and durations so that the conversion process is reduced essentially to a format conversion rather than a detection process. User play input is compared with the Tablature model and scored. The score feedback allows the user to progressively converge his or her play on the Tablature model by repetitive practice, the net result being the progressive enhancement of the skill of playing the guitar music content in the media content.

A simple example of Presentation Enhancement is the association of the extracted music events with the application objects that control non-skill related elements of the application presentation objects. For instance, the dominant color derived from Palette Detection 1121 metadata events could be associated with the application presentation object driving the application background color. Thus, the application background color could be forced to change to a specific color depending on the chord that the user played and the instances of that same chord in the media content could be highlighted so that the user could anticipate the same chord in following parts of the music.

From these examples one may see that Output Staging 1140 is a type of rule-based system where combinations of categorized detected video and audio events are associated with application presentation objects. After execution of the desired rule set, the aggregated metadata and application object associations are transferred to Metadata Repository 1150 from which they are retrieved to be combined with the media content and the application objects when the application is requested by the user as set out in FIGS. 6 and 7. The consolidated metadata records may be formatted in a variety of ways that are not central to the essence of the present invention. One format which is useful for ease of transfer between services over a network is the JavaScript Object Notation (JSON), a lightweight data-interchange format (see http://json.org/), however, it will be evident to a practitioner of average skill in the art that there are many choices of data format and specific programming styles for the functions described in FIG. 11 and that the present invention could evidently be implemented in many such forms.

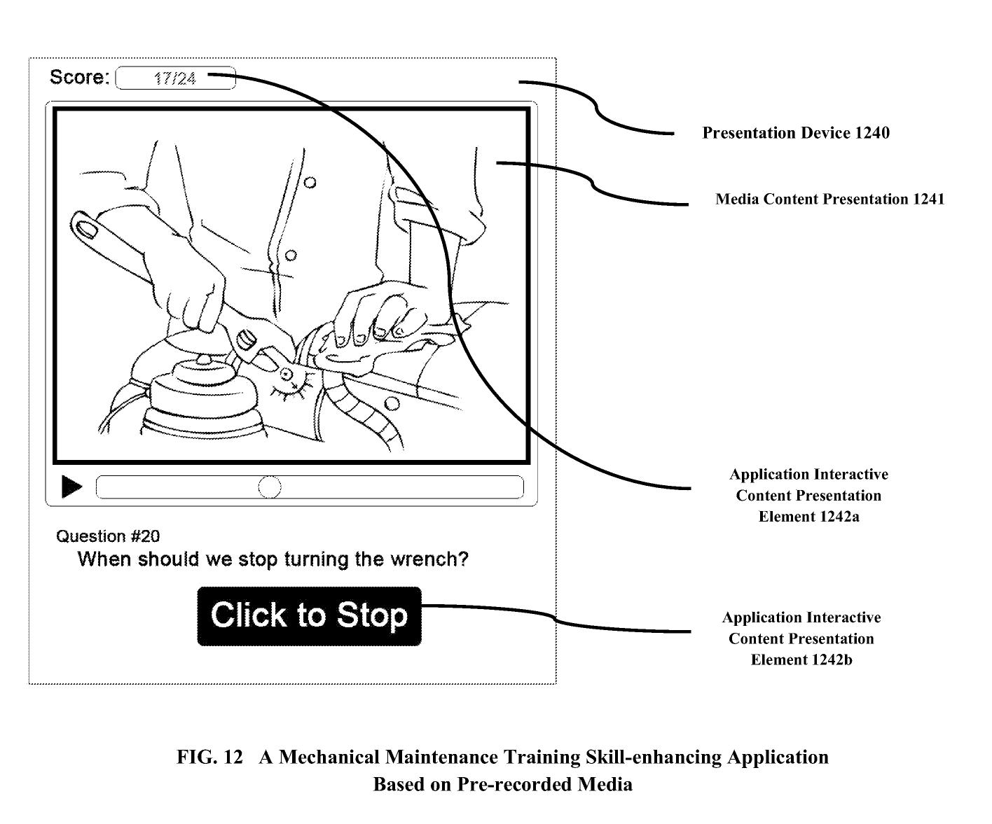

FIG. 12 describes an illustrative embodiment of the current invention, a loosely-coupled mechanical maintenance skill-enhancing application based on pre-recorded media. A barrier to creating training materials for a wide range of instructional fields is the necessity of building custom media content for each segment of training and modifying the media content for each new learning goal. With the emergence of such new streaming media services such as YouTube and the methods of the current invention, creators of training materials can create training computer applications from existing public media content or post their own media content and re-use it for different, training purposes without modifying the media content or facing the necessity of creating a media distribution platform for their materials.

The described skill-enhancing application shows one method by which someone might be trained in aspects of a mechanical maintenance task by using an application based on pre-recorded media content in a format that scores their success in absorbing the details of the maintenance techniques applicable to the presented media content. The media content may be from available generally available pre-recorded sources or from specifically produced pre-recorded instructional content. FIG. 12 will be described as a specific illustrative example of the general descriptions set out in FIG. 5 and FIGS. 7 and 6 FIG. 12 shows the elements of the user's view of such a loosely-coupled application as it might appear on the user's display, Presentation Device 1240, which is represented as Presentation Device 540 in FIG. 5. Within the Presentation Device 1240 are two types of presentation objects, the Application Interactive Content Presentation Elements 1242a, and 1242b, corresponding to Interactive Content Presentation 542 in FIG. 5 and Media Content Presentation 1241 corresponding to Media Content Presentation 541 in FIG. 5.

The Media Content Presentation 1241 may be any accessible pre-recorded media content stream that includes training material the player wishes to learn. In the illustration FIG. 12 the media content stream is assumed to include machine maintenance techniques that the player wishes to learn. The machine maintenance media content is presented in the Media Content Presentation 1241 area of the Presentation Device 1240. As the media content stream is presented to the player, the Application Interactive Content Presentation Element 1242b presents an series of questions with multiple choice answers relative to the machine maintenance media content that is being played in the Media Content Presentation 1241 area. The task of the user is to indicate the correct answer to the presented question through an Input Device according to time constraints as the media proceeds. The Application Interactive Content Presentation Element 1242a shows the player a measure of his or her success in responding to the questions in the Media Content Presentation 1241 as a game score. Questions and answers might be based on visual or auditory clues in the pre-recorded media content.

We can see how this illustrative computer game would be created and distributed by reference to FIG. 7. There, a New Application Media Request 710 would be generated to the Streaming Media Content Service 702 which would send Pre-recorded Media Content Stream 712 to the Streaming Media Analysis Service 703. From Streaming Media Analysis Specification 714, which gives the analysis requirements for this class of media content, Streaming Media Analysis Service 703 would analyze the media content audio and video generating training event timestamps. The resultant Audio Metadata 716 and Video Metadata 715 would be transferred to Metadata Repository Service 704. In parallel, the timeline of the streaming media content and the timestamps of the converted training events would be extracted and transferred to Metadata Repository Service 704 as Subsidiary Metadata 717.

As well as Streaming Media Analysis Specifications 713, the Game Designer would provide Event and Action Definitions 714 that provide functions in Application Definition Service 705 to generate and render the question and answer content on the players presentation device and to compare the player's answers and timing to the media content metadata, scoring success or failure and rending the player's score in a score presentation object Game Interactive Content Presentation Element 1242b.

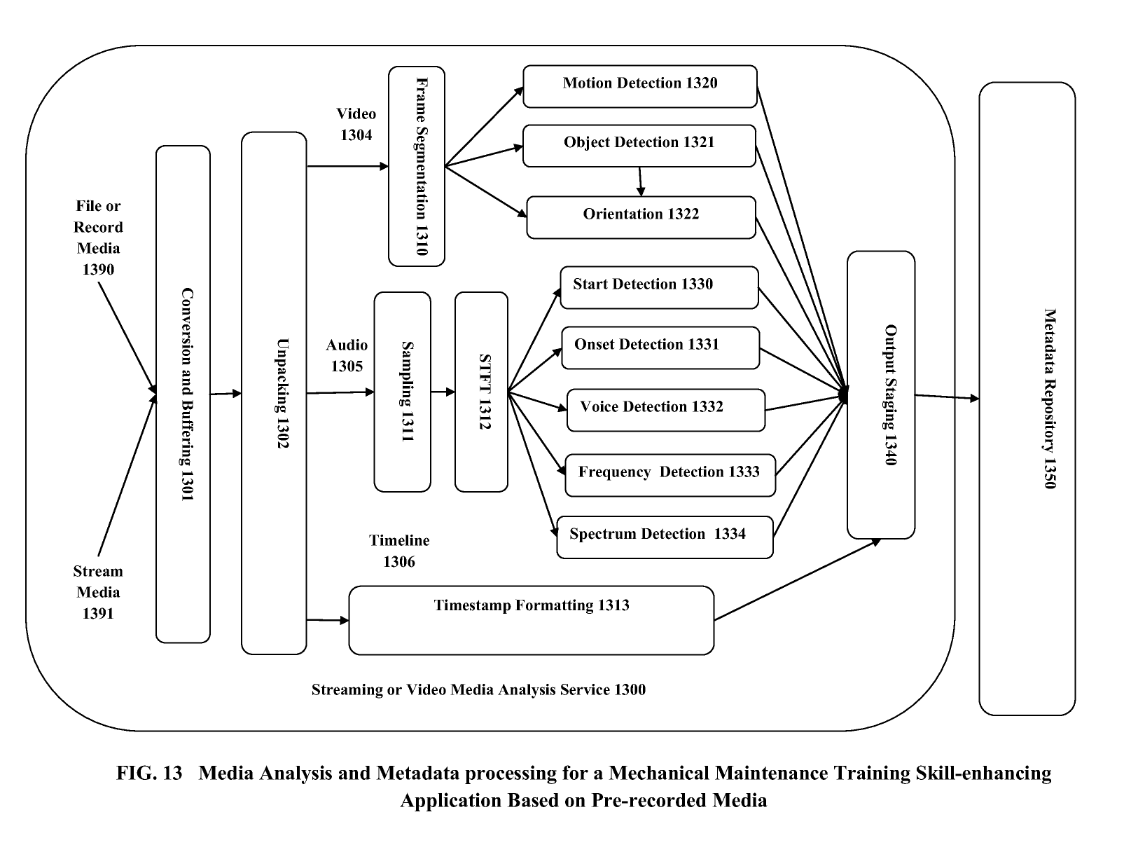

It will be evident to a practitioner of average skill in the art that only some of the training event metadata that is described can be reliably extracted automatically from the media content stream and that most of the question and answer data required for Game Interactive Presentation Element 942b will have to be added by human intervention. However, the basic skeleton of media and game interactive structure can be automated and one can expect more and more automation to evolve as the art of pattern recognition processing matures. FIG. 13 provides a more detailed description of the media analysis, metadata extraction and processing techniques which could be used in this exemplary application. The basic advantages of the loosely-coupled game architecture and the ability to use media content that is accessible independently of the game logic are retained. Having created the metadata for the media content stream, the skill-enhancing application is ready for delivery and play.

A player wishing to play the mechanical maintenance training application relative to the media content requests the game through End-User Client Device Service 700, generating now an Existing Application Request 720 to Application Coordination Service 701 which generates three different requests, Existing Application Streaming Media Request 721 to Streaming Media Content Service 702, Metadata Request 722 to Metadata Repository Service 704 and Events and Actions Request 723 to Application Definition Service 705. The Streaming Media Content Service 702 returns the Pre-recorded Media Content Stream 724 to the End-User Client Device Service 700, more particularly, to the Media Player 514 and hence to the Media Content Presentation 541 in the Media Presentation Device 540 in FIG. 5. The Metadata Repository Service 704 returns the Metadata 726 and the Application Definition Service 705 returns the Events and Actions Definitions 725 to the End-User Client Device Service 700, more particularly to the Game Logic 512 and Synchronizing Functions 513 which deliver the Application Presentation Data 516 to the Game Interactive Content Render 515 under control of User Control Data 504 generating the Interactive Content Presentation 542 on the user's Media Presentation Device 540.

FIG. 13 is a diagram providing a more detailed representation of the metadata extraction and processing service of the mechanical maintenance skill-enhancing representative embodiment of the present invention described in FIG. 12 above. The descriptions of FIG. 13 apply to the two general embodiments of the present invention described in FIG. 6 and FIG. 7. In FIG. 13 the input of File or Record Media 1390 into Conversion and Buffering 1301 of Streaming Media or Video Media Analysis Service 1300 is equivalent to the input Pre-recorded Video Media Content 612 into Video Media Analysis Service 603 in FIG. 6 or the Pre-recorded Media Content Stream 712 into Streaming Media Analysis Service 703 in FIG. 7.

To simplify processing, File or Record Media 1390 and Stream Media 1391 are converted into a common format temporary data structure in Conversion and Buffering 1301 where they may be accessed by the various analytical functions. Next, the function Unpacking 1302 removes the media data contents from the media container and separates the media into video content, Video 1304, audio content, Audio 1305 and time synchronization content, Timeline 1306. Video 1304 is passed to Frame Segmentation 1310 where it is divided into individual frame data for processing in the signal pattern analysis stage Motion Detection 1320, Object Detection 1321 and Orientation 1322. Isolating objects within the visual content, identifying their range of motion and orientation is a foundation for leading the learner through recognition of the mechanical components in normal operation and aberrations from norms which are important to maintenance tasks, particularly when correlated to detected audio events and patterns. The techniques of video motion detection are well known, with an extensive literature. Software for performing motion detection is available from multiple commercial and open source projects, described, for instance at The Code Project online at http://www.codeproject.com/KB/audio-video/Motion_Detection.aspx by Andrew Kirillov.

The techniques of object recognition within digital media are well known in relation to the field of computer vision in multiple application fields. Recently, the technology has become of more general interest in the field of Augmented Reality wherein video images of real world scenes and objects are enhanced by the superimposition of computer data relating to the viewer's interests. Extensive literature on the field and sources of both commercial and open source technologies may be found in the Proceedings of the International Symposium on Augmented Reality (ISMAR 2000-20009). The techniques of detecting and representing Object Orientation are intrinsic to the processes of object recognition and motion detection. Object orientation metadata is included here separately because the processes of mechanical maintenance often depend critically on orientation and changes of orientation of mechanical parts. The extracted metadata events and patterns from Motion Detection 1320, Object Recognition 1321 and Orientation 1322 are passed to Output Staging 1340 for correlation with other metadata events and patterns and formatting for transfer to Metadata Repository 1350.

Audio 1305 is passed to Sampling 1311 where the native samples of the source audio are sub-sampled into a number of discrete sample windows to facilitate further processing. The samples are passed to STFT 1312 where a Short-time Fourier Transform (STFT) is performed. The short-time Fourier transform (STFT), or alternatively short-term Fourier transform, is a function used to determine the sinusoidal frequency and phase content of local sections of a signal as it changes over time. The Fourier Transform is well known to signal processing practitioners. The STFT is widely used in music analysis. References to many of the signal processing functions described in this section may be found in the proceedings of The International Society for Music Information Retrieval (ISMIR, http://ismir.net/). The output spectrum analysis of the STFT is passed to a bank of detection functions to extract specific events and patterns in the audio that are useful indicators of voice patterns. It should be noted that the data presented by Audio 1305 is typically not just data relating to the operation of mechanisms. Large amounts of the data may not be mechanism audio at all, but silence, voice narration, environmental background, various types of noise and other extraneous audio artifacts. Thus, the central task of the detection functions is to differentiate focal metadata from other types of audio in the signal. Start Detection 1330 detects the start of the audio signal and reconciles the start of the audio with the start of the video for synchronization purposes. It distinguishes the start of the audio from the start of signals since the start of an audio track may have a lead period of digital silence. After a start of signal is differentiated from a start of audio track, the audio phenomena are categorized to differentiate silence, narration, noise and other extraneous artifacts from the targeted mechanical audio content.

Several technologies may be applied in this process, including silence filtering using the program Sox (http://sox.sourceforge.net) and voiced/unvoiced detection (see Li, Yipeng; Wang, DeLiang Singing Voice Separation from Monaural Recordings ISMIR 2006 Proceedings). Start Detection 1330 uses the same techniques to detect pauses within the target mechanical content in the audio data and the end of the mechanical content in the audio data. Some of the non-mechanical events such as narration may be retained as metadata indicative of the points of importance within the mechanical audio data. In the case that the media content is mechanical audio with narration voice content, Voice Detection 1332 separates human voice events from other audio events. Frequency Detection 1333 and Spectrum Detection 1334 are functions that extract fundamental frequencies and balance of harmonics for a sound artifact in the audio data.

The conversion of Audio 1305 from its amplitude form, to a frequency distribution form in STFT 1312 makes frequency and spectrum detection simple. This metadata is essential to identify an audio signature that identifies the normal sound and characteristic aberrations of a mechanism in operation. Identifying such sound signatures is often required to diagnose mechanical problems or to calibrate mechanisms in maintenance tasks. As the various mechanical and non-mechanical artifacts are detected, Onset Detection 1331 detects the precise onset and end of each detected event, again with techniques well known to practitioners of the art, for instance, the OnsetsDS Library by Dan Stowell (see http://onsetsds.sourceforge.net/) and You, Wei; Dannenberg, Roger B. Polyphonic Music Note Onset Detection Using Semi-Supervised Learning ISMIR 2007.

The extracted metadata events and patterns from Start Detection 1330, Onset Detection 1331, Voice Detection 1332. Frequency Detection 1333 and Spectrum Detection 1334 are passed to Output Staging 1340 for correlation with other metadata events and patterns and formatting for transfer to Metadata Repository 1350. Timeline 1306 is passed to Timestamp Formatting 1313 where the native timecode of the source media is normalized to a format that assures the audio, video content and the various classes of extracted metadata events and patterns are compatible and synchronizable with each other. The timeline data is passed to Output Staging 1340 where it is used as a synchronization reference as the various metadata events and patterns are assigned to categories associated with specific user inputs and presentation objects. Output Staging 1340 sorts the metadata events and patterns and associates them with specific application presentation objects before passing the consolidated metadata with timeline synchronization data to Metadata Repository 1350.

The primary function of this association is to create a Skill Model for the user to emulate or identify. One simple example of Skill Modeling is the association of the video metadata extracted by Object Detection 1321 and Orientation 1322 with the audio metadata extracted by Frequency Detection 1333 and Spectrum Detection 1334.

A specific combination of these metadata events combined with Onset Detection 1331 and Motion Detection 1320 output metadata events might be assigned to an association with the Application Interactive Content Presentation Element 1242b in FIG. 12 wherein the user is asked to identify the correct adjustment point of a mechanical assembly by clicking on a button when the adjustment “sounds” correct. The user attempts to synchronize his or her adjustment decision with the visual and auditory model by clicking the button when they estimate the correct object orientation and sound spectrum has been reached. User play input is compared with the metadata model and scored. The score feedback allows the user to progressively converge his or her adjustment decisions by repetitive practice, the net result being the progressive enhancement of the maintenance skill represented in the media content.

From these examples one may see that Output Staging 1340 is a type of rule-based system where combinations of categorized detected video and audio events are associated with application presentation objects. After execution of the desired rule set, the aggregated metadata and application object associations are transferred to Metadata Repository 1150 from which they are retrieved to be combined with the media content and the application objects when the application is requested by the user as set out in FIGS. 6 and 7. The consolidated metadata records may be formatted in a variety of ways that are not central to the essence of the present invention. One format which is useful for ease of transfer between services over a network is the JavaScript Object Notation (JSON), a lightweight data-interchange format (see http://json.org/), however, it will be evident to a practitioner of average skill in the art that there are many choices of data format and specific programming styles for the functions described in FIG. 13 and that the present invention could evidently be implemented in many such forms.

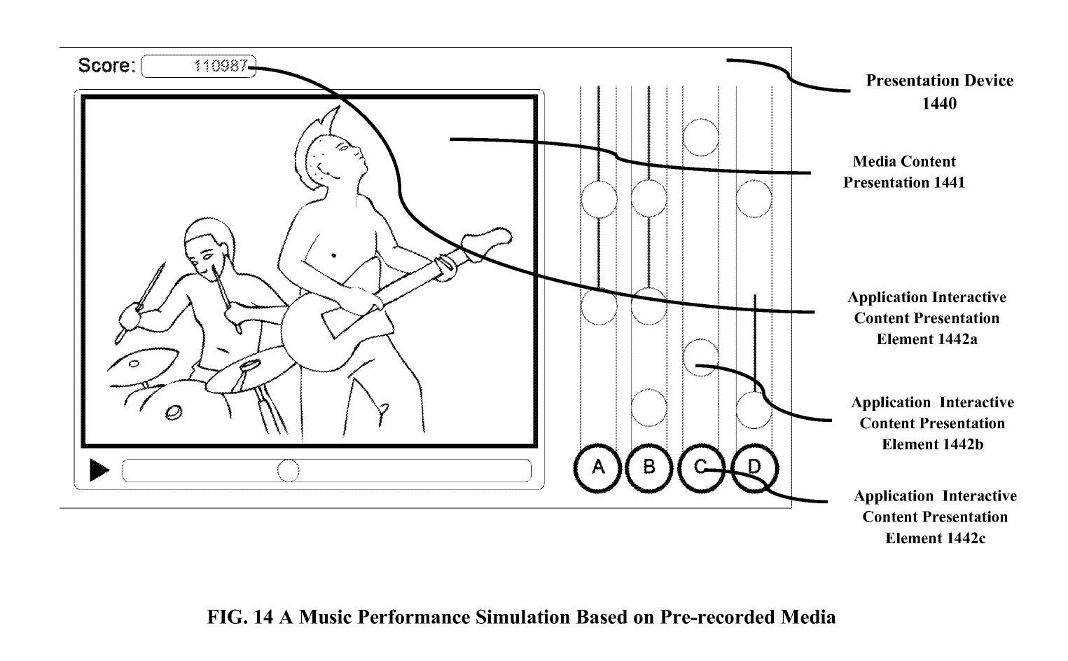

FIG. 14 describes an illustrative embodiment of the current invention, a loosely-coupled music performance simulation application based on pre-recorded media. There is a long history of many instances of music performance simulation games. However, a barrier to creating such games has always been the necessity of building closely-coupled custom representations of the performers for each instance of the simulation. This constraint is seen clearly in such popular music simulation games as Guitar Hero from Activision and Rock Band from MTV/Viacom. Such simulations have long and expensive production cycles associated with creating the custom animations of performers, relating the animations to the specific music content and synchronizing the specific music with the animation model.

Using the methods of the current invention, creators of music games can use the existing public media content of music videos (from such services such as iTunes from Apple Computer, for example) or streaming media (from such services as YouTube or Spotify) to create and distribute music simulation applications without any need to create a visual representation of the music performance at all. Rather, the pre-recorded media content provides the visual representation which is loosely-coupled and synchronized to the interactive simulation content based on metadata extracted from the media content. Thus, developers can use existing public media content or their own media content and re-use it for different game purposes without modifying the media content or facing the necessity of creating complex, time-consuming and expensive animation models or creating a music media distribution platform.

The described skill-enhancing application example shows how users may play a music performance simulation application along with a wide variety of pre-recorded media content in a format that scores their success in mimicking the performance presented in the pre-recorded media content. FIG. 14 will be described as a specific illustrative example of the general descriptions set out in FIG. 5 and FIGS. 6 and 7. FIG. 14 shows the elements of the player's view of such a loosely-coupled application as it might appear on the user's display, Presentation Device 1440, presented as Presentation Device 540 in FIG. 5. Within the Presentation Device are two types of presentation object, the Application Interactive Content Presentation Elements 1442a, 1442b and 1442c, corresponding to Interactive Content Presentation 542 in FIG. 5 and Media Content Presentation 1441 corresponding to Media Content Presentation 541 in FIG. 5.

The Media Content Presentation 1441 may be any accessible pre-recorded media content stream that includes a music performance the player wishes to play along with. In the illustration of FIG. 14, the media content stream is assumed to include a musical performance along with which the player wishes to play. The media performance content stream presented in the Media Content Presentation 1441 area of the Presentation Device 1040. In prior art music performance simulation applications this representation would be a tightly-coupled animation model program component. In the present invention, it is the pre-recorded media content without any need to program an animation model. As the pre-recorded media content is presented to the player, the Application Interactive Content Presentation Element 1442b presents an interactive simulation interface consisting of a series of vertical time tracks with animated tokens descending toward target circles labeled A, B, C, D, the Application Interactive Content Presentation Element 1442c, representing the time of the current performance moment in the music performance.

The task of the player is to activate controls on an input device in the pattern of the tokens as they reach the target circles. The patterns of tokens may reflect any features of the media performance based on visual or auditory features. The input device that initiates the user patterns may be any device that can be interfaced to the PC or Video Game Console 510 in FIG. 5, which might include a keyboard, a game controller, a custom music simulation instrument, or even a wireless mobile phone. The Application Interactive Content Presentation Element 1442a shows the player a measure of his or her success in synchronizing his or her input patterns to match the animated token flow as a game score.

We can see how this illustrative computer game would be created and distributed by reference to FIG. 6 or FIG. 7. In FIG. 6, a New Game Media Request 610 would be generated to the Streaming Media Content Service 602 which would send Pre-recorded Media Stream 612 to the Media Analysis Service 603. From Media Analysis Objects 614 giving the analysis requirements for this class of media content, Media Analysis Service 603 would analyze the music performance media content audio and video events to extract patterns that can be represented as patterns of animated tokens. The resultant Auditory Metadata 616 and Visual Metadata 615 would be transferred to Metadata Repository Service 604. In parallel, the timeline of the streaming media content and the timestamps of the converted simulation pattern events would be extracted and transferred to Metadata Repository Service 604 as Subsidiary Metadata 617.

As well as Media Analysis Objects 613, the Game Designer would provide Application Objects 613 that provide functions in Application Objects Service 605 to generate and render the time tracks and token patterns, to compare the player's input device data patterns and timing to the media content metadata, to score success or failure and to render the player's score in a score presentation object Application Content Presentation Element 1042a. Having created the metadata for the media content stream, the skill-enhancing application is ready for delivery and play. A player wishing to play the music performance simulation application relative to the media content requests the game through End-User Client Device Service 600, generating now an Existing Application Request 620 to Application Coordination Service 601 which generates three different requests, Existing Application Request 621 to Video Media Content Service 602, Metadata Request 622 to Metadata Repository Service 604 and Application Objects Request 623 to Application Definition Service 605. The Video Media Content Service 602 returns the Pre-recorded Video Media Content 624 to the End-User Client Device Service 600, more particularly, to the Media Player 514 and hence to the Media Content Presentation 541 in the Media Presentation Device 540 in FIG. 5. The Metadata Repository Service 604 returns the Metadata 626 and the Application Objects Service 605 returns the Application Objects 625 to the End-User Client Device Service 600, more particularly to the Application Logic 512 and Synchronizing Functions 513 which deliver the Application Presentation Data 516 to the Interactive Content Render 515 under control of User Control Data 504 generating the Interactive Content Presentation 542 on the user's Media Presentation Device 540.

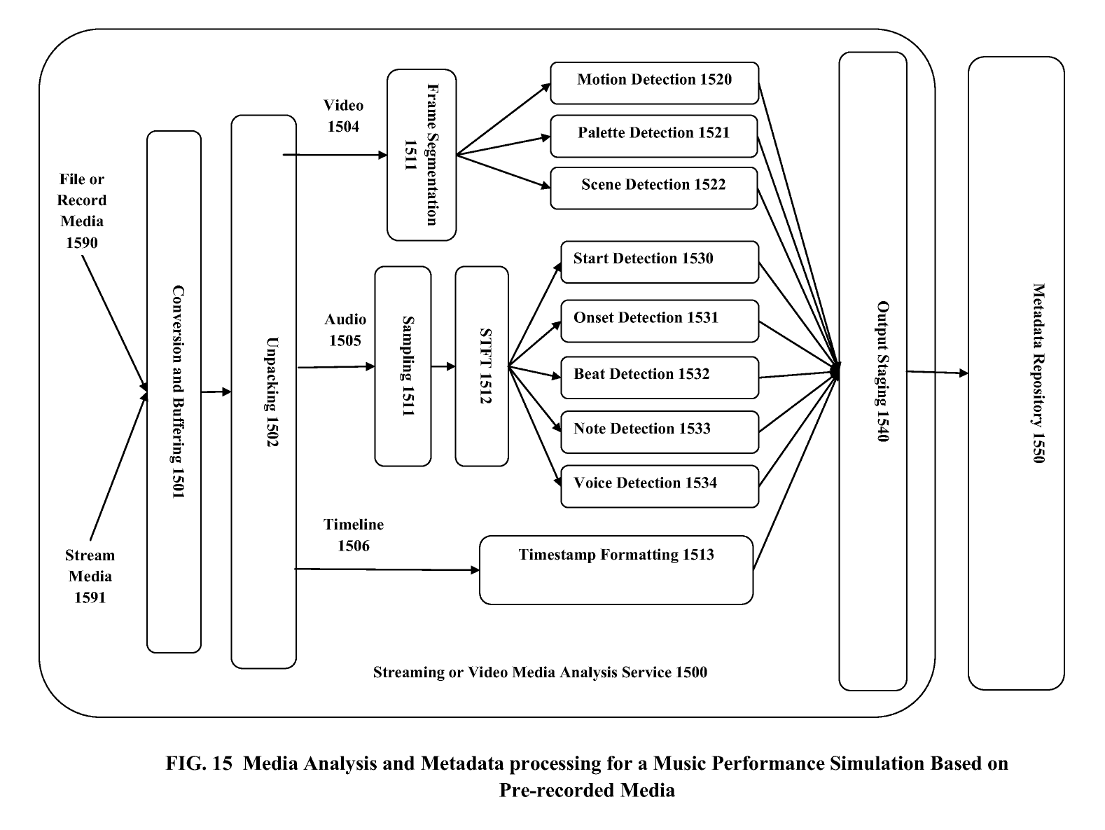

FIG. 15 presents a more detailed description of the process of media analysis and the extraction and processing of metadata as applied to the music performance simulation application described in FIG. 14. The descriptions of FIG. 15 apply to the two general embodiments of the present invention described in FIG. 6 and FIG. 7. In FIG. 15 the input File or Record Media 1590 into Conversion and Buffering 1501 of Streaming Media or Video Media Analysis Service 1500 relates to the input Pre-recorded Video Media Content 612 into Video Media Analysis Service 603 in FIG. 6 and the input Stream Media 1591 into Streaming Media or Video Media Analysis Service 1500 relates to the input Pre-recorded Media Content Stream 712 into Streaming Media Analysis Service 703 in FIG. 7. To simplify processing, File or Record Media 1590 and Stream Media 1591 are converted into a common format temporary datastructure in Conversion and Buffering 1501 where they may be accessed by the various analytical functions. Next, the function Unpacking 1502 removes the media data contents from the media container and separates the media into video content, Video 1504, audio content, Audio 1505 and time synchronization content, Timeline 1506.

Video 1504 is passed to Frame Segmentation 1511 where it is divided into individual frame data for processing in the signal pattern analysis stage Motion Detection 1520, Palette Detection 1521 and Scene Detection 1522. Motion events and repetitive motion patterns are useful indicators of performance patterns when correlated to detected audio events and patterns. The techniques of video motion detection are well known with an extensive literature and software for performing motion detection is available from multiple commercial and open source projects, described, for instance at The Code Project online at http://www.codeproject.com/KB/audio-video/Motion_Detection.aspx by Andrew Kirillov. Detection of the dominant color palette of video frames, changes in dominant color palette and repetitive sequences of color palette changes are indicative of music performance events when correlated to detected audio events and patterns. As well, the dominant color palette of the media content is useful in constructing the interactive application presentation objects where it may be used to set the color of the backgrounds and presentation objects so that they appear to be a part of the media content presentation even though the media content presentation is independent of the interactive objects. The techniques of detecting the dominant color palette of video frames are well known in relation to the field of video compression where the dominant color distribution is used set up efficient code tables for maximal compression efficiency.

A simple color palette detection function may be constructed by sampling the video pixel color at regular intervals and ordering the results to show the highest rates of repeated colors. Scene detection is a useful indicator of significant events in the video stream and scene change events that correlate with other audio events and patterns are often useful indicators of performance patterns. Scene detection software is used extensively in video editing to automatically divide raw video footage into clips for ease of editing. Scene detection software is widely available from commercial vendors, for example HandySaw from Davis Software.

As well, the underlying technology is used in video compression techniques to establish points at which a new compression redundancy lookup table should be instantiated. This is based on the fact that scene changes are typically transition points that introduce a different mix of visual artifacts that require a different code table for maximal compression. The extracted metadata events and patterns from Motion Detection 1520, Palette Detection 1521 and Scene Detection 1522 are passed to Output Staging 1540 for correlation with other metadata events and patterns and formatting for transfer to Metadata Repository 1550.

Audio 1505 is passed to Sampling 1511 where the native samples of the source audio are sub-sampled into a number of discrete sample windows to facilitate further processing. The samples are passed to STFT 1512 where a Short-time Fourier Transform (STFT) is performed. The short-time Fourier transform (SIFT), or alternatively short-term Fourier transform, is a function used to determine the sinusoidal frequency and phase content of local sections of a signal as it changes over time. The Fourier Transform is well known to signal processing practitioners. The STFT is widely used in music analysis. References to many of the signal processing functions described in this section may be found in the proceedings of The International Society for Music Information Retrieval (ISMIR, http://ismir.net/). The output spectrum analysis of the STFT is passed to a bank of detection functions to extract specific events and patterns in the audio that are useful indicators of music performance patterns.

It should be noted that the data presented by Audio 1505 is not just music data. Large amounts of the data may not be music at all, but silence, narration, clapping, cheering and various types of noise. Thus, the central task of the detection functions is to differentiate music metadata from other types of audio in the signal. Start Detection 1530 detects the start of the audio signal and reconciles the start of the audio with the start of the video for synchronization purposes. It distinguishes the start of the audio from the start of signals since the start of an audio track may have a lead period of digital silence. After a start of signal is differentiated from a start of audio track, the audio phenomena are categorized to differentiate silence, spoken introductions or narration, clapping and noise from the music content. Several technologies may be applied in this process, including silence filtering using the program Sox (http://sox.sourceforge.net) and voiced/unvoiced detection (see Li, Yipeng; Wang, DeLiang Singing Voice Separation from Monaural Recordings ISMIR 2006 Proceedings).

Start Detection 1530 uses the same techniques to detect pauses within the music content in the audio data and the end of the music content in the audio data. Some of the non-music events such as clapping, cheering and whistling may be retained as metadata indicative of the points of importance within the music performance. Beat Detection 1532, Note Detection 1533 and Voice Detection 1534 are functions that differentiate musical events and patterns from within a polyphonic audio signal. Beat Detection 1532 acts to create a pattern of events that indicate appropriate time to synchronize notes. There is extensive literature on this type of processing. See, for instance, Simon Dixon (http://www.elec.qmul.ac.uk/people/simond/pub/2007/jnmr07.pdf), Evaluation of the Audio Beat Tracking System BeatRoot, Journal of New Music Research, 36 (1), 39-50, 2007.

Note Detection 1533 separates different melodic from percussion and rhythm events and patterns. There is an extensive literature on such processing in the various Proceedings of the ISMIR. Voice Detection 1534 separates human voice events from other musical and audio events. As already noted in description of Start Detection 1530, voice detection is also used to differentiate non-musical voice events such as introductions and narrations from musical events such as singing. As the various musical and non-musical artifacts are detected, Onset Detection 1531 detects the precise onset and end of each detected event, again with techniques known to practitioners of the art, for instance, the OnsetsDS Library by Dan Stowell (see http://onsetsds.sourceforge.net/) and You, Wei; Dannenberg, Roger B. Polyphonic Music Note Onset Detection Using Semi-Supervised Learning ISMIR 2007.

The extracted metadata events and patterns from Start Detection 1530, Onset Detection 1531, Beat Detection 1532, Note Detection 1533 and Voice Detection 1534 are passed to Output Staging 1540 for correlation with other metadata events and patterns and formatting for transfer to Metadata Repository 1550.

Timeline 1506 is passed to Timestamp Formatting 1513 where the native timecode of the source media is normalized to a format that assures the audio, video content and the various classes of extracted metadata events and patterns are compatible and synchronizable with each other. The timeline data is passed to Output Staging 1540 where it is used as a synchronization reference as the various metadata events and patterns are assigned to categories associated with specific user inputs.

Output Staging 1540 sorts the metadata events and patterns and associates them with specific application presentation objects before passing the consolidated metadata with timeline synchronization data to Metadata Repository 1550. This association falls into two general categories—Skill Modeling and Presentation Enhancement. One simple example of Skill Modeling is the association of extracted music events with the application objects that represent them to the user. For instance, a specific combination of Beat Detection 1532 output metadata events with Note Detection 1533 output metadata events might be assigned to an association with a token on the “A” token track of the Application Interactive Content Presentation Element 1442b in FIG. 14. This track might be a representation of the percussion line of the music. Other combinations might represent pitch relationships, each on their specific track.

Thus the metadata provide a model of the music structure as it is performed in the media content which is visualized through the associated Application Interactive Content Presentation Elements. The user attempts to synchronize his or her input gestures with the visualized model. User input is compared with the model and scored. The score feedback allows the user to progressively converge on the model by repetitive practice. A simple example of Presentation Enhancement is the association of extracted music events with the application objects that control non-skill related elements of the application presentation objects. For instance, the dominant color derived from Palette Detection 1521 metadata events could be associated with the application presentation object driving the application background color. Thus, the application background color could be forced to change to match each change in the video content.

From these examples one may see that Output Staging 1540 is a type of rule-based system where combinations of categorized detected video and audio events are associated with application presentation objects. After execution of the desired rule set, the aggregated metadata and application object associations are transferred to Metadata Repository 1550 from which they are retrieved to be combined with the media content and the application objects when the application is requested by the user as set out in FIGS. 6 and 7. The consolidated metadata records may be formatted in a variety of ways that are not central to the essence of the present invention. One format which is useful for ease of transfer between services over a network is the JavaScript Object Notation (JSON), lightweight data-interchange format (see http://json.org/), however, it will be evident to a practitioner of average skill in the art that there are many choices of data format and specific programming styles for the functions described in FIG. 15 and that the present invention could evidently be implemented in many such forms.

The preceding descriptions of FIGS. 8 to 15 represent simple illustrative examples of embodiments of the current invention. It will be evident to an average practitioner of the art that there are many more potential embodiments of the invention based on selection of different combinations of metadata in pre-recorded media which are indicative of skills that specific populations may wish to enhance. Equally, it will be evident that the presented example embodiments might be created using the invention in a variety of physical forms and that the combinations of metadata which might be indicative of a skill to be enhanced are variable, the same overall goal achievable through different combinations of extracted metadata. The examples presented are to clarify the invention by describing several representative examples of its application and are not intended to limit the breadth of application of the invention, nor to limit the variability of any particular application of the invention Accordingly, the scope of the invention is limited only by the scope of the claims appended below.

What is claimed is:

1. A method for creating and delivering skill-enhancing computer applications from a source of pre-recorded video content, selected from the group comprising pre-recorded streaming data, video file data, video database records, given a source content instance identifier, the method comprising the steps of:
(a) identifying existing accessible skill enhancing application metadata and user-interactive program objects,
(b) extracting metadata illustrative of a desired skill not found in step (a) from the content instance,
(c) storing said extracted metadata in a metadata repository,
(d) creating user-interactive program objects illustrative of said desired skill,
(e) storing said user-interactive program objects in a program objects repository,
(f) retrieving from metadata repository and said program objects repository extracted metadata and user-interactive program objects,
(g) displaying the content instance to a user,
(h) executing said user-interactive program objects to provide choices to the user based on said extracted metadata,
(i) comparing user's choices with said extracted metadata,
(j) providing feedback to the user indicative of success relative to the user's choices in matching extracted metadata illustrative of said desired skill.

2. The method of claim 1, wherein step (a) comprises querying a database that matches source content instances with accessible skill enhancing application metadata and user-interactive program objects.

3. The method of claim 1, wherein step (b) comprises extracting from the source content instance time-line metadata sufficient to synchronize external program object events to the source content and at least one metadata event illustrative of the desired skill.

4. The method of claim 1, wherein step (b) comprises extracting from the source content instance time-line metadata sufficient to synchronize external program object events to the source content instance and at least one metadata event illustrative of the desired skill derived from the graphic content of the source content instance.

5. The method of claim 1, wherein step (b) comprises extracting from the source content instance time-line metadata sufficient to synchronize external program object events to the source content instance and at least one metadata event illustrative of the desired skill derived from the audio content of the source content instance.

6. The method of claim 1, wherein step (b) comprises extracting from the source content instance time-line metadata sufficient to synchronize external program object events to the source content instance and at least one metadata event illustrative of the desired skill derived from the audio content of the source content instance, plus at least one metadata event illustrative of the desired skill derived from the graphic content of the source content instance.

7. The method of claim 1, wherein step (c) comprises storing the extracted metadata on the end-user's computing device.

8. The method of claim 1, wherein step (c) comprises storing the extracted metadata on a remote server in a network.

9. The method of claim 1, wherein step (d) comprises programming the user-interactive program objects in a programming language that executes on a virtual machine running on the user's computing device.

10. The method of claim 1, wherein step (d) comprises programming the user-interactive program objects in a programming language that executes as a compiled program running on the user's computing device.

11. The method of claim 1, wherein the source content instance is stored on the end-user's computing device.

12. The method of claim 1, wherein the source content instance is retrieved from a network streaming media server under the control of the skill-enhancing application provider.

13. The method of claim 1, wherein the source content instance is stored on a remote server in a network which is not under the control of the skill-enhancing application provider.

14. The method of claim 1, wherein step (e) comprises storing the user-interactive program objects on the end-user's computing device.

15. The method of claim 1, wherein step (e) comprises storing the user-interactive program on a remote server in a network.

16. The method of claim 1, wherein step (h) comprises playing the source content on a personal computer or game console.

17. The method of claim 1, wherein step (h) comprises playing the source content on a mobile phone or other wireless device.

18. The method of claim 1, wherein step (i) comprises comparing the timing of the user's choice interactions with the timing of the extracted metadata.

19. The method of claim 1, wherein step (i) comprises comparing the user's choice of quantitative or qualitative attributes presented to him or her with the qualitative or quantitative attributes described in the extracted metadata.

20. The method of claim 1, wherein step (j) comprises altering at least one user-interactive program object presentation state to reflect the comparison of the user's choice relative to the extracted metadata.

21. The method of claim 1, wherein step (j) comprises altering at least one attribute of the source content instance playback presented to the user to reflect the comparison of the user's choice relative to the extracted metadata.

22. The method of claim 1, wherein step (j) comprises altering at least one attribute of the source content instance playback and at least one user-interactive program object presentation state presented to the user to reflect the comparison of the user's choice relative to the extracted metadata.

23. The method of claim 1, wherein step (j) comprises altering at least one audio attribute of the source content instance playback presented to the user to reflect the comparison of the user's choice relative to the extracted metadata.

24. The method of claim 1, wherein step (j) comprises altering at least one graphic attribute of the source content instance playback presented to the user to reflect the comparison of the user's choice relative to the extracted metadata.
